(19) United States
(12) Patent Application Publication
(10) Pub. No.: US 2019/0187949 A1
(43) Pub. Date: Jun. 20, 2019

(54) NON-TRANSITORY COMPUTER READABLE MEDIUM WITH PROGRAM, INFORMATION PROCESSING METHOD, AND INFORMATION PROCESSING TERMINAL

(71) Applicant: LINE Corporation, Tokyo (JP)

(72) Inventors: Kenichi Sugimoto, Tokyo (JP); Heechan Yang, Tokyo (JP)

(73) Assignee: LINE Corporation, Tokyo (JP)

(21) Appl. No.: 16/282,710

(22) Filed: Feb. 22, 2019

Related U.S. Application Data
(63) Continuation of application No. PCT/JP2017/024832, filed on Jul. 6, 2017.

(30) Foreign Application Priority Data
Aug. 24, 2016 (JP) 2016-163615

(51) Int. Cl. G06F 3/14; G06F 7/08; G06F 3/0482; G06F 3/0484; H04L 12/58

(52) U.S. Cl. CPC G06F 3/1454; G06F 7/08; G06F 3/0482; G06Q 10/02; H04L 51/08; H04L 51/16; G06F 3/0484

(57) ABSTRACT

A non-transitory computer-readable recording medium has computer readable instructions stored thereon, which when executed, cause an information processing terminal that includes a display and at least one processor, to execute a method. The method includes displaying a screen of a talk room that displays one or more contents transmitted and received in a group including the information processing terminal and another information processing terminal; displaying a list of objects corresponding to information input by a user; displaying on the screen of the talk room an object selected by the user from among the objects included in the list; transmitting the object to said another information processing terminal; and displaying on the screen of the talk room an extended function corresponding to the object in chronological order in the talk room as a content in the talk room.

### CROSS-REFERENCE TO RELATED APPLICATIONS

This U.S. non-provisional application is a continuation application of, and claims the benefit of priority under 35 U.S.C. § 365(c) from, PCT International Application PCT/JP2017/024832 filed on Jul. 6, 2017, which designates the U.S., and is based upon and claims the benefit of priority of Japanese Patent Application No. 2016-163615 filed on Aug. 24, 2016, the entire contents both of which are incorporated herein by reference.

### FIELD

The present disclosure relates to a non-transitory computer-readable medium on which a program is recorded, an information processing method, and/or an information processing terminal.

### BACKGROUND

Conventionally, techniques have been known that search for products or services by using an application provided on the Web or by a company.

In recent years, techniques referred to as “chat bot” and the like have been known that exchange chat with users, by using techniques of natural language processing (NLP) and natural language understanding (NLU) based on artificial intelligence (AI). Also, techniques have been known for making reservations for various services by using this chat bot. In this case, for example, a user invites the chat bot to a chat room, exchanges a chat with the chat bot to search for products and services.

However, according to such a conventional technology, depending on the accuracy of processed results of natural language understanding and the like based on AI, there is a problem that there is a case where a service desired by a user cannot be appropriately provided. Also, in the conventional technology, there is no consideration for the case of searching for products or services in a group including multiple users.

### SUMMARY

According to an example embodiment in the present disclosure, a non-transitory computer-readable recording medium has computer readable instructions stored thereon, which when executed, cause an information processing terminal that includes a display and at least one processor, to execute a method. The method includes displaying a screen of a talk room that displays one or more contents transmitted and received in a group including the information processing terminal and another information processing terminal; displaying a list of objects corresponding to information input by a user; displaying on the screen of the talk room an object selected by the user from among the objects included in the list; transmitting the object to said another information processing terminal; and displaying on the screen of the talk room an extended function corresponding to the object in chronological order in the talk room as a content in the talk room.

### BRIEF DESCRIPTION OF DRAWINGS

FIG. 1 is a diagram illustrating a configuration of a communication system according to an example embodiment;

FIG. 2 is a diagram illustrating an example of a sequence of a process in a communication system according to an example embodiment;

FIG. 3 is a flowchart illustrating an example of a process of a terminal according to a first example embodiment;

FIG. 4A is a diagram illustrating an example (first example) of a display screen on a terminal according to the first example embodiment;

FIG. 4B is a diagram illustrating an example (second example) of a display screen on a terminal according to the first example embodiment;

FIG. 4C is a diagram illustrating an example (third example) of a display screen on a terminal according to the first example embodiment;

FIG. 4D is a diagram illustrating an example (fourth example) of a display screen on a terminal according to the first example embodiment;

FIG. 4E is a diagram illustrating an example (fifth example) of a display screen on a terminal according to the first example embodiment;

FIG. 5 is a diagram illustrating an example of stamp information;

FIG. 6A is a diagram illustrating an example (first example) of a display screen of a Web site of an external server, on a terminal according to the first example embodiment;

FIG. 6B is a diagram illustrating an example (second example) of a display screen of a Web site of an external server, on a terminal according to the first example embodiment;

FIG. 6C is a diagram illustrating an example (third example) of a display screen of a Web site of an external server, on a terminal according to the first example embodiment;

FIG. 7A is a diagram illustrating an example (first example) of a display screen of a result of an execution request on a terminal according to the first example embodiment;

FIG. 7B is a diagram illustrating an example (second example) of a display screen of a result of an execution request on a terminal according to the first example embodiment;

FIG. 8 is a diagram illustrating an example of a sequence of a process in a communication system 1 according to a second modified example of the first example embodiment;

FIG. 9 is a flowchart illustrating an example of a process of a terminal 20A according to the second modified example of the first example embodiment;

FIG. 10 is a flowchart illustrating an example of a process of a terminal according to a second example embodiment;

FIG. 11A is a diagram illustrating an example (first example) of a display screen on a terminal according to the second example embodiment;

FIG. 11B is a diagram illustrating an example (second example) of a display screen on a terminal according to the second example embodiment;

FIG. 11C is a diagram illustrating an example (third example) of a display screen on a terminal according to the second example embodiment;

FIG. 11D is a diagram illustrating an example (fourth example) of a display screen on a terminal according to the second example embodiment;

FIG. 11E is a diagram illustrating an example (fifth example) of a display screen on a terminal according to the second example embodiment;

FIG. 11F is a diagram illustrating an example (sixth example) of a display screen on a terminal according to the second example embodiment;

FIG. 11G is a diagram illustrating an example (seventh example) of a display screen on a terminal according to the second example embodiment;

FIG. 12A is a diagram illustrating an example (first example) of a display screen of a Web site of an external server, on a terminal according to the second example embodiment;

FIG. 12B is a diagram illustrating an example (second example) of a display screen of a Web site of an external server, on a terminal according to the second example embodiment;

FIG. 12C is a diagram illustrating an example (third example) of a display screen of a Web site of an external server, on a terminal according to the second example embodiment;

FIG. 13A is a diagram illustrating an example (first example) of a display screen of a result of an execution request on a terminal according to the second example embodiment;

FIG. 13B is a diagram illustrating an example (second example) of a display screen of a result of an execution request on a terminal according to the second example embodiment;

FIG. 14A is an example (first example) of a display screen on a terminal when receiving a payment request operation;

FIG. 14B is an example (second example) of a display screen on a terminal when receiving a payment request operation;

FIG. 14C is an example (third example) of a display screen on a terminal when receiving a payment request operation;

FIG. 14D is an example (fourth example) of a display screen on a terminal when receiving a payment request operation;

FIG. 14E is an example (fifth example) of a display screen on a terminal when receiving a payment request operation;

FIG. 14F is an example (sixth example) of a display screen on a terminal when receiving a payment request operation; and

FIG. 15 is a flowchart illustrating an example of a process of a terminal 20A according to a modified example of the second example embodiment.

### DETAILED DESCRIPTION

<Observance of Confidentiality of Communication>

Note that when implementing the disclosure in this specification, it should be implemented with observance of legal matters relating to the confidentiality of communication of the involved parties.

Example embodiments will be described with reference to the drawings.

According to an example embodiment, it is possible to provide a non-transitory computer-readable medium with a program, an information processing method, and/or an information processing terminal that are capable of using an extended function by a simple operation in a group including multiple users.

<System Configuration>

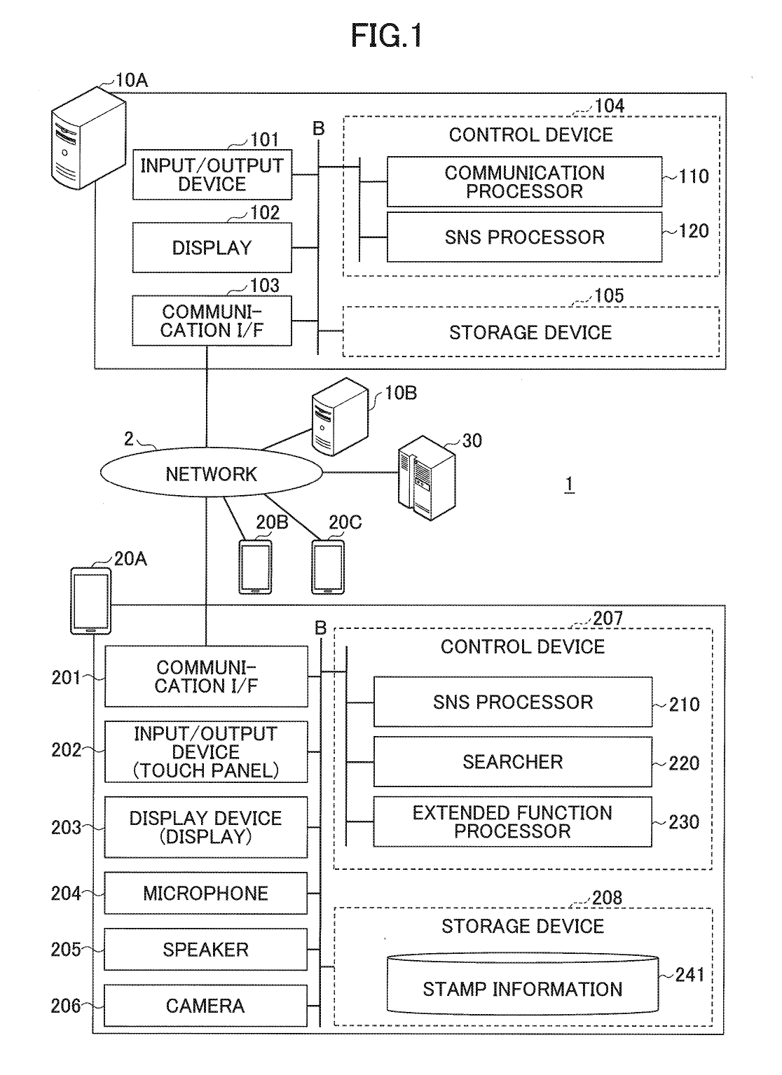

FIG. 1 is a diagram illustrating a configuration of a communication system 1 according to an aspect of the example embodiment. As illustrated in FIG. 1, in the communication system 1, a server 10, terminals 20 (terminal 20A, terminal 20B, and terminal 20C), and an external server 30 are connected via a network 2. The server 10 provides a service, such as SNS (Social Network Service), that realizes transmission and reception of contents such as messages, still images, moving images, and stamps between the terminals 20 including a terminal 20 used by the user via the network 2. Note that the number of terminals 20 connected to the network 2 is not limited.

The network 2 plays a role of connecting one or more terminals 20 with one or more servers 10. In other words, the network 2 means a communication network that provides a connection path through which a terminal 20 can transmit and receive data after connecting to a server 10.

For example, one or more parts of the network 2 may be a wired network and/or a wireless network. The network 2 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a part of the Internet, a part of a public switched telephone network (PSTN), a mobile phone network, integrated service digital networks (ISDNs), wireless LANs, long term evolution (LTE), code division multiple access (CDMA), Bluetooth (registered trademark), satellite communication, and a combination of two or more of these. However, in the present disclosure, the network 2 is not limited to these. Also, the network 2 may also include one or more networks.

The terminal 20 (terminal 20A, terminal 20B, or terminal 20C) may be any terminal as long as it can implement functions described in the example embodiment. The terminal 20 is typically a smart phone and may also be a mobile phone (e.g., a feature phone), a computer (e.g., a desktop-type, a laptop-type, a tablet-type, etc.), a media computer platform (e.g., a cable/satellite TV set-top box, a digital video recorder, etc.), a handheld computing device (e.g., a PDA (personal digital assistant), an e-mail client, etc.), a wearable terminal (a glasses-type device, a watch-type device, etc.), or any other type of a computer or a communication platform. However, in the example embodiments, the terminal 20 is not limited to these. Also, the terminal 20 may be expressed as an information processing terminal.

Since the configurations of the terminal 20A, the terminal 20B, and the terminal 20C are basically the same, in the following description, any of these may be referred to as the terminal 20, and when necessary, the terminal 20A may be referred to as the host terminal 20A, the terminal 20B may be referred to as another terminal 20B, and the terminal 20C may be referred to as yet another terminal 20C.

The server 10 has a function of providing a predetermined service to the terminal 20. The server 10 may be any type of information processing apparatus as long as it can implement functions described in the example embodiment. The server 10 is typically a server device and may also be a computer (e.g., a desktop-type, a laptop-type, a tablet-type, etc.), a media computer platform (e.g., a cable/satellite TV set-top box, a digital video recorder, etc.), a handheld computing device (e.g., a PDA (personal digital assistant), an e-mail client, etc.), or any other type of a computer or a communication platform. However, in the example embodiments, the server 10 is not limited to these. Also, the server 10 may be expressed as an information processing apparatus.

The external server 30 has a function of providing predetermined services such as purchase of products and reservation of services to the terminal 20. The external server 30 may be any information processing apparatus as long as it can realize the functions described in the following example embodiments.

<Hardware (HW) Configuration>

With reference to FIG. 1, a HW configuration of each device included in the communication system 1 will be described.

(1) HW Configuration of Terminal

The terminal 20 includes a control device (CPU: Central Processing Unit) 207, a storage device 208, a communication I/F (interface) 201, an input/output device 202, a display device 203, a microphone 204, a speaker 205, and a camera 206. These elements of the HW of the terminal 20 are connected to each other, for example, via a bus B.

The communication I/F 201 transmits and receives various items of data via the network 2. The communication may be executed by wire and/or by radio, and any communication protocol may be used as long as mutual communication can be executed.

The input/output device 202 includes an input device for inputting various operations on the terminal 20 and an output device for outputting processed results processed on the terminal 20. The input/output device 202 may have the input device and the output device integrated, or have the input device and the output device separated.

The input device is implemented by any one of all types of devices or a combination of these devices that can receive input from the user and can transmit information related to the input to the control device 207. The input device is typically implemented by a touch panel or the like, to detect a contact by a pointer, such as a finger of the user or a stylus, and the contact position, and to transmit the coordinates of the contact position to the control device 207. Meanwhile, the input device may be implemented by an input device other than the touch panel. The input device includes, for example, hardware keys represented by a keyboard or the like, a pointing device such as a mouse, a camera (operation input via moving images), and a microphone (operation input by voice). However, the input device is not limited to these.

The output device is implemented by any one or a combination of all types of devices capable of outputting processed results processed by the control device 207. The output device is typically implemented by a touch panel or the like. Meanwhile, the output device may be implemented by an output device other than a touch panel. For example, a speaker (audio output), a lens (e.g., 3D (three dimensional) output or hologram output), a printer, and the like may be included. However, the output device is not limited to these.

The display device 203 is implemented by any one of all types of devices or a combination of these that can execute displaying according to display data written in a frame buffer. The display device 203 is typically implemented by a monitor (e.g., a liquid crystal display or an OELD (organic electroluminescence display)). The display device 203 may be a head-mounted display (HMD). Also, the display device 203 may be implemented by projection mapping, hologram, or a device that is capable of displaying images, text information, and the like in the air or the like (which may be a vacuum). Note that these display devices 203 may be capable of displaying display data in 3D. However, the display device 203 is not limited to these.

In the case where the input/output device 202 is a touch panel, the input/output device 202 and the display device 203 may have substantially the same size and shape to be arranged to face each other.

The control device 207 has a circuit that is physically structured to execute functions implemented by codes or instructions included in a program, and is implemented by, for example, a data processing device built in the hardware.

The control device 207 is typically a central processing unit (CPU), and also may be a microprocessor, a processor core, multiprocessors, an ASIC (application-specific integrated circuit), or an FPGA (field programmable gate array). However, the control device 207 is not limited to these.

The storage device 208 has a function of storing various programs and various items of data required when the terminal 20 operates. The storage device 208 is implemented by various storage media such as an HDD (hard disk drive), an SSD (solid state drive), a flash memory, a RAM (random access memory), a ROM (read-only memory), and the like. However, the storage device 208 is not limited to these.

In the terminal 20, a program P is stored in the storage device 208, and the control device 207 running this program P executes processes corresponding to respective functional units included in the control device 207. In other words, the program P stored in the storage device 208 realizes the functions executed by the control device 207 on the terminal 20. As discussed in more detail below, the program P, when executed by the control device 207, may configure the control device 207 as a special purpose computer that obtains and embeds an extended function in a chat room in chronological order amongst the communications exchanged within the chat room such that the extended function is visible to and selectable by the first user associated with the first information processing terminal and a second user associated with the second information processing terminal. Therefore, the control device 207 may improve the functioning of the terminal 20 itself by electronically providing tools that improve the efficiency of decision making amongst the participants in the chat room.

The microphone 204 is used for inputting audio data. The speaker 205 is used for outputting audio data. The camera 206 is used for obtaining data of moving images.

(2) HW Configuration of Server

The server 10 includes a control device (CPU) 104, a storage device 105, a communication I/F (interface) 103, an input/output device 101, and a display 102. These elements of the HW of the server 10 are mutually connected, for example, via a bus B.

The control device 104 has a circuit that is physically structured to execute functions implemented by codes or instructions included in a program, and is implemented by, for example, a data processing device built in the hardware.

The control device 104 is typically a central processing unit (CPU), and may be a microprocessor, a processor core, multiprocessors, an ASIC, or an FPGA. However, in the present disclosure, the control device 104 is not limited to these.

The storage device 105 has a function of storing various programs and various items of data required for the server 10 to operate. The storage device 105 is implemented by various storage media such as an HDD, an SSD, a flash memory, and the like. However, the storage device 105 is not limited to these.

The communication I/F 103 transmits and receives various items of data via the network 2. The communication may be executed by wire or by radio, and any communication protocol may be used as long as mutual communication can be executed. The communication I/F 103 has a function of executing communication with the terminal 20 via the network 2. The communication I/F 103 transmits various items of data to the terminal 20 according to an instruction from the control device 104. Also, the communication I/F 103 receives various items of data transmitted from the terminal 20, and transmits the data to the control device 104.

The input/output device 101 is implemented by a device that inputs various operations on the server 10. The input/output device 101 is implemented by any one of all types of devices or a combination of these devices that can receive input from the user and can transmit information related to the input to the control device 104. The input/output device 101 is typically implemented by hardware keys represented by a keyboard or the like, a pointing device such as a mouse, and the like. Note that the input/output device 101 may include, for example, a touch panel, a camera (operation input via moving images), and a microphone (operation input by voice). However, the input/output device 101 is not limited to these.

The display 102 is typically implemented by a monitor (e.g., a liquid crystal display or an GELD (organic electroluminescence display)). Note that the display 102 may be a head-mounted display (HMD) or the like. Note that these displays 102 may be capable of displaying display data in 3D. However, the display 102 is not limited to these.

In the server 10, the program P is stored in the storage device 105, and the control device 104 running this program P executes processes corresponding to respective functional units included in the control device 104. In other words, the program P stored in the storage device 105 realizes the functions executed by the control device 104 on the server 10.

Each example embodiment in the present disclosure will be described assuming that it is implemented by the CPU(s) of the server 10 and/or the terminal 20 executing the program P.

The control device 207 of the terminal 20 and/or the control device 104 of the server 10 may be implemented not only by a CPU but also by a logic circuit (hardware) or a dedicated circuit formed in an integrated circuit (IC) chip, an LSI (Large Scale Integration) chip, or the like. Also, these circuits may be implemented by one or more integrated circuits, and multiple processes described in the example embodiment may be implemented by a single integrated circuit. Also, an LSI may also be referred to as a VLSI, a super LSI, an ultra LSI, or the like depending on the degree of integration.

Also, the program P (software program/computer program) of the example embodiments may be provided in a state stored in a computer-readable recording medium. The recording medium can store the program in a “non-transitory tangible medium”.

When appropriate, the recording medium may include one or more semiconductor-based or other integrated circuits (ICs) such as field programmable gate arrays (FPGAs) or application specific integrated circuits (ASICs); a hard disk drive (HDD), a hybrid hard drive (HHD), an optical disk, an optical disk drive (ODD), a magneto-optical disk, a magneto-optical drive, a floppy diskette, a floppy disk drive (FDD), a magnetic tape, a solid state drive (SSD), a RAM drive, a secure digital card or drive, any other suitable recording medium, or any suitable combination of two or more of these. When appropriate, the recording medium may be volatile, non-volatile, or may have a combination of volatility and non-volatility. Note that the recording medium is not limited to these examples, and may be any device or medium as long as it can store the program P.

The server 10 and/or the terminal 20, for example, can read the program P stored in the recording medium and execute the read program P to realize the functions of multiple functional units described in each embodiment.

Also, the program P may be provided to the server 10 or the terminal 20 via any transmission medium (a communication network, a broadcasting wave, or the like) capable of transmitting the program. The server 10 and/or the terminal 20 realize functions of multiple functional units described in the respective example embodiments by executing the program P downloaded via, for example, the Internet or the like.

Each embodiment in the present disclosure can also be implemented in a form of a data signal embedded in a carrier wave in which the program P is embodied by electronic transmission. Note that the program can be implemented by using a script language such as ActionScript, JavaScript (registered trademark), and the like; an object-oriented programming language such as Objective-C, Java (registered trademark), and the like; and a markup language such as HTML5 and the like. However, the program is not limited to be implemented by these languages.

### First Example Embodiment

A first example embodiment relates to an information processing method of searching for a product or a service by using a stamp in a talk room of a messaging service of an SNS that executes communication among multiple specific users. This enables to search for products and services while performing communication in a group including the multiple users.

Note that the contents described in the first example embodiment can also be applied to a second example embodiment and the like, which will be described later.

<Functional Configuration>

(1) Functional Configuration of Terminal

A functional configuration of the terminal 20 will be described with reference to FIG. 1. The terminal 20 includes an SNS processor 210, a searcher 220, and an extended function processor 230. These functions are realized by reading one or more programs stored in the storage device 208 and executing them by the control device 207 (e.g., a CPU).

The SNS processor 210 executes various processes that use a messaging service of an SNS by using the server 10. For example, in a talk room, the SNS processor 210 transmits and receives contents such as character string messages, stamps, images, and the like with the other terminals via the server 10.

The searcher 220 searches for a stamp (an example of an “object”) according to information input from the user.

On the screen of a talk room, the extended function processor 230 executes a process of an extended function corresponding to a transmitted/received stamp that has a command (search query) function.

(2) Functional Configuration of Server

With reference to FIG. 1, a functional configuration of the server 10 will be described. The server 10 includes a communication processor 110 and an SNS processor 120. These functions are realized by reading one or more programs stored in the storage device 105 and executing them by the control device 104 (e.g., a CPU).

The communication processor 110 has a function of executing communication with the external server 30 and each of the terminals 20 via the network 2. The communication processor 110 transmits various items of data to the terminal 20 according to a command from the SNS processor 120. Also, the communication processor 110 receives various items of data transmitted from the terminal 20 and indicates the data to the SNS processor 120.

The SNS processor 120 receives a content such as a message addressed to the user of the terminal 20, and transmits the content to the terminal 20 of the addressed user.

The storage device 105 stores programs and various items of information of the users of the SNS. For example, the storage device 105 stores an address as the destination of a content addressed to each user, information on the account of the user of the terminal 20, and the like.

<Process>

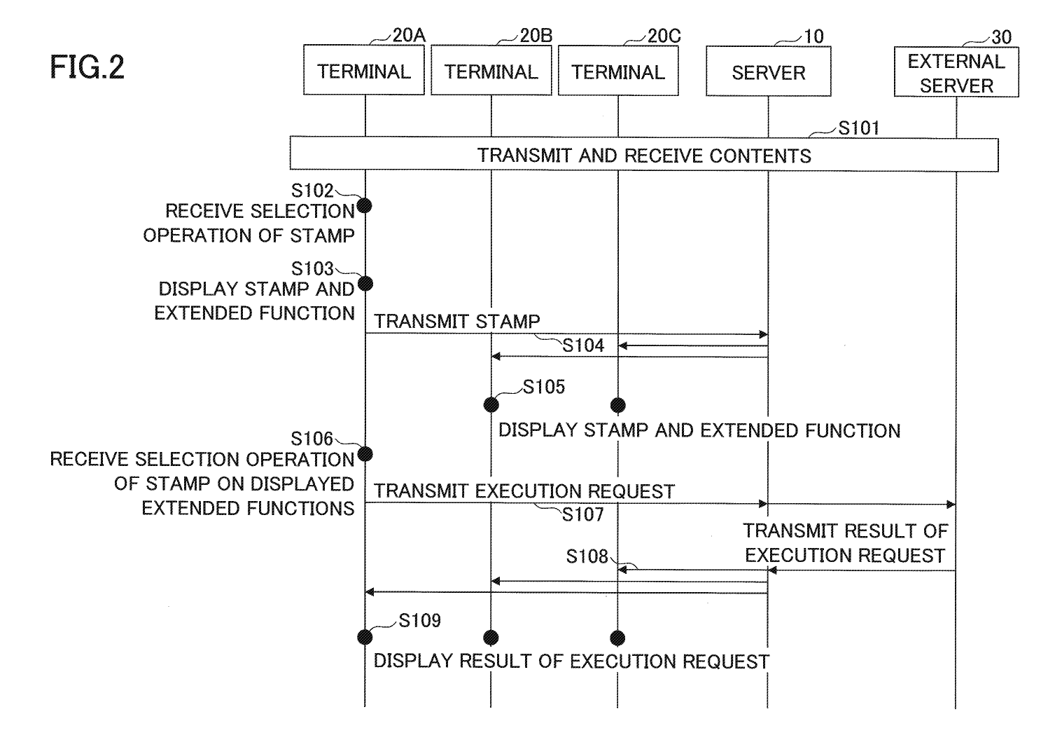

Next, with reference to FIG. 2, a process in the communication system 1 according to an example embodiment will be described. FIG. 2 is a diagram illustrating an example of a sequence of a process in the communication system 1 according to the example embodiment.

In FIG. 2, an operation sequence is illustrated in the case where a service using a stamp having a command (search query) function is provided when contents are being transmitted and received among the multiple terminals 20A, 20B and 20C by using the SNS messaging service.

At Step S101, contents are transmitted and received among the multiple terminals 20A, 20B and 20C via the server 10, which is a device to provide the SNS messaging service. For example, contents are transmitted and received by using a talk room in which a history of transmission and reception of contents among the multiple terminals 20A, 20B and 20C is displayed as a list.

At Step S102, the SNS processor 210 of the terminal 20A receives a selection operation of a stamp having a command function from the user of the terminal 20A.

At Step S103, the extended function processor 230 of the terminal 20A displays the selected stamp and an extended function associated with the stamp.

At Step S104, the SNS processor 210 of the terminal 20A transmits the selected stamp to the terminal 20B and the terminal 20C via the server 10.

At Step S105, the extended function processor 230 of each of the terminal 20B and the terminal 20C displays the received stamp and the extended function associated with the stamp.

At Step S106, the extended function processor 230 of the terminal 20A receives a selection operation in the extended function from the user of the terminal 20A. Note that the selection operation in the extended function can be executed not only on the terminal 20A that transmitted the stamp but also on the terminal 20B or the terminal 20C that received the stamp. Here, although an example will be described in which the selection operation is received on the terminal 20A, the following description is similarly applicable to the case where a selection operation is received on the terminal 20B or the terminal 20C.

At Step S107, the extended function processor 230 of the terminal 20A requests the external server 30 to execute a process corresponding to the received operation. In this case, the terminal 20A or the server 10 having received the request from the terminal 20A may receive an ID (room ID) to identify the messaging service of the SNS among the terminal 20A, the terminal 20B, and the terminal 20C, to indicate the ID to the external server 30.

At Step S108, the external server 30 transmits a result of the execution request to the terminal 20A, the terminal 20B, and the terminal 20C via the server 10. Here, the external server 30 specifies the room ID, to transmit the result of the execution request to the server 10.

At Step S109, the extended function processor 230 of each of the terminal 20A, the terminal 20B, and the terminal 20C displays the result of the execution request received from the external server 30 via the server 10.

<Process on Terminal 20>

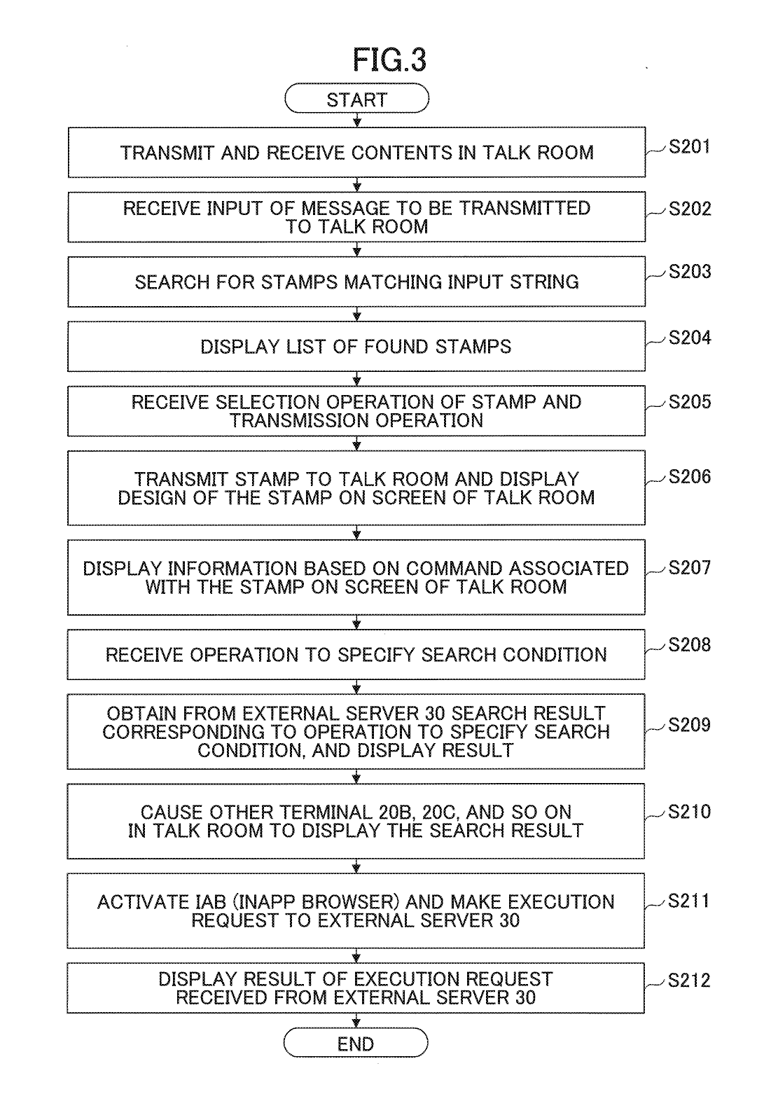

Next, with reference to FIG. 3, a process on the terminal 20A will be described. FIG. 3 is a flowchart illustrating an example of the process on the terminal 20A according to the first example embodiment.

At Step S201, the SNS processor 210 of the terminal 20A transmits and receives contents via the server 10 in the talk room of the SNS messaging service that includes the users of the other terminals 20B and 20C as members. In this talk room, transmitted and received contents are displayed in order of transmission and reception (so as to be sorted in chronological order).

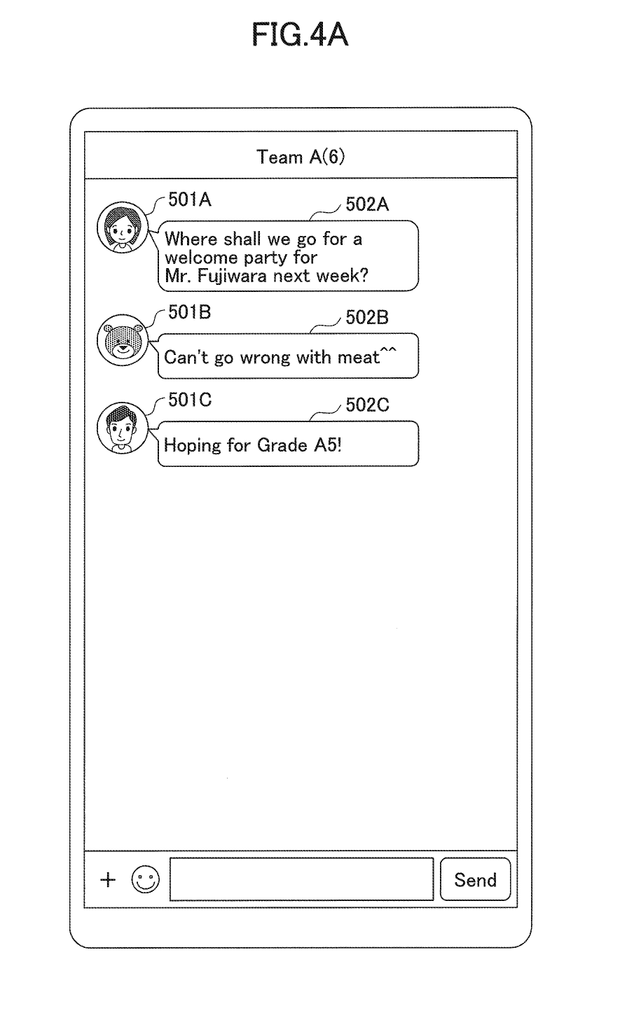

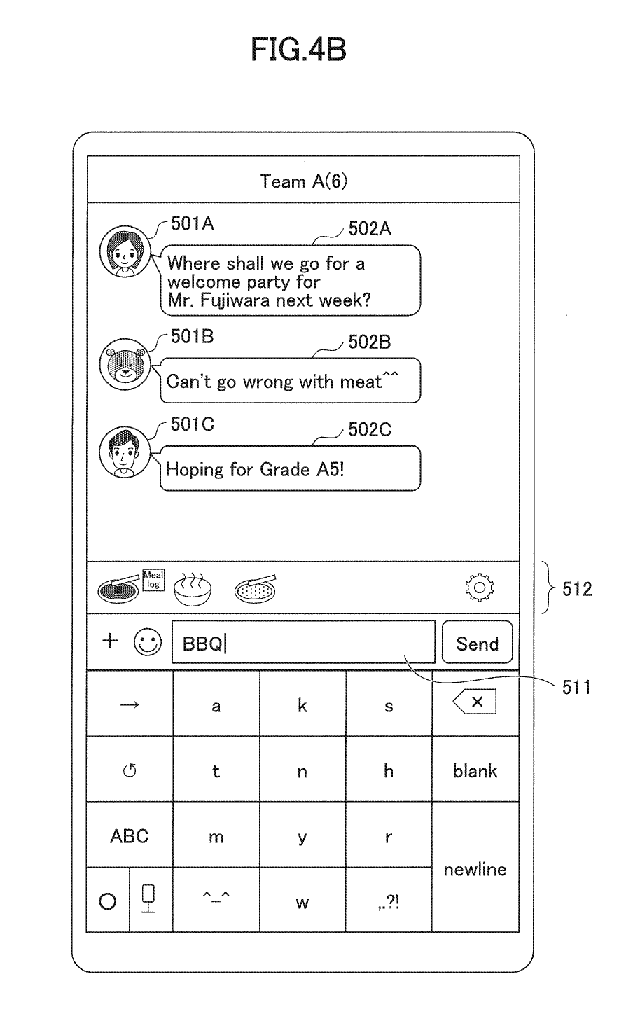

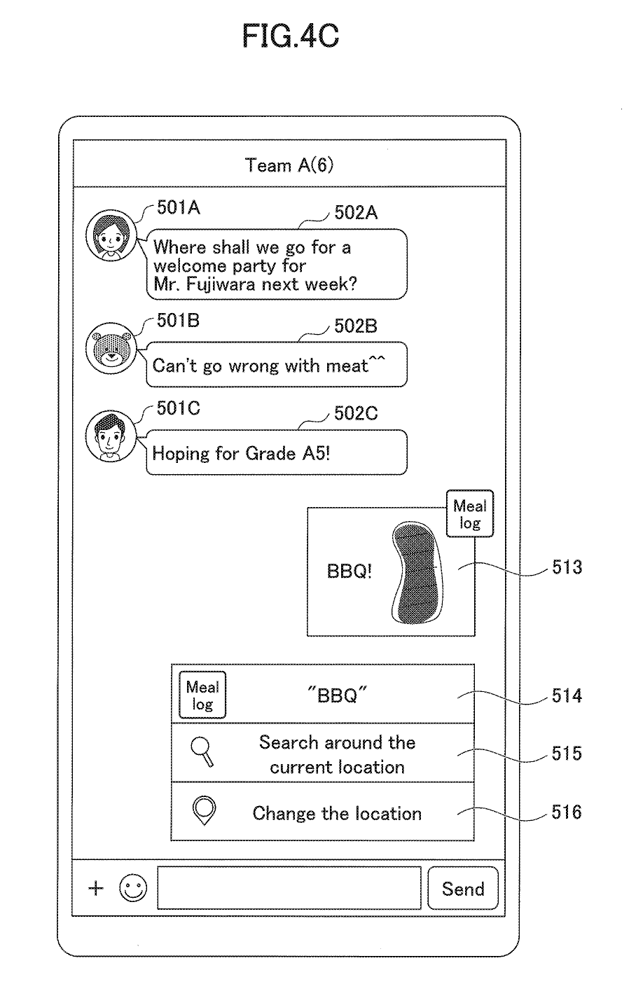

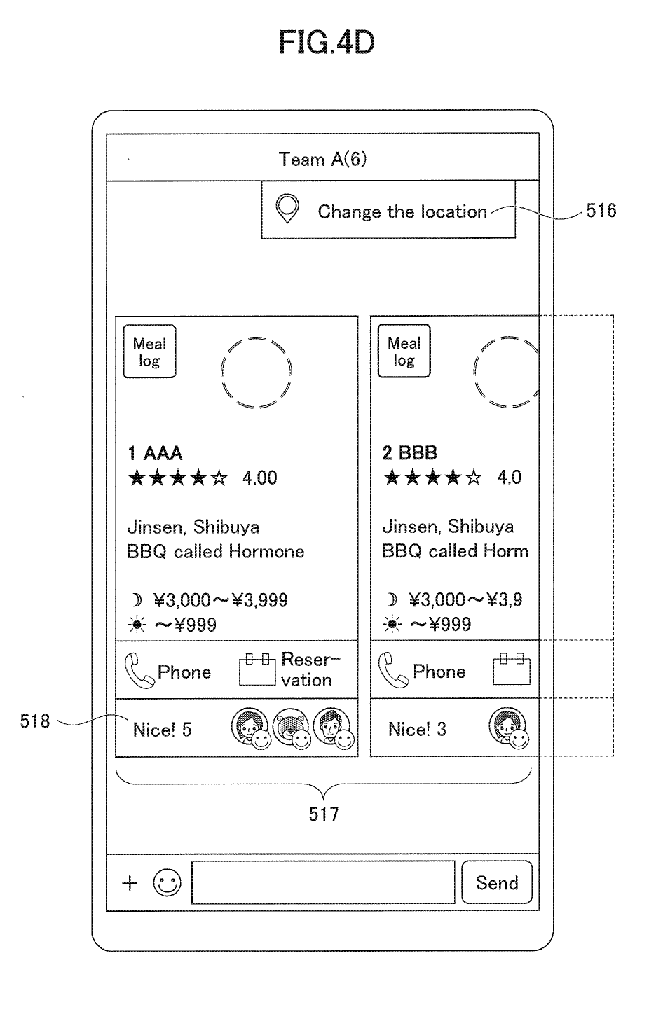

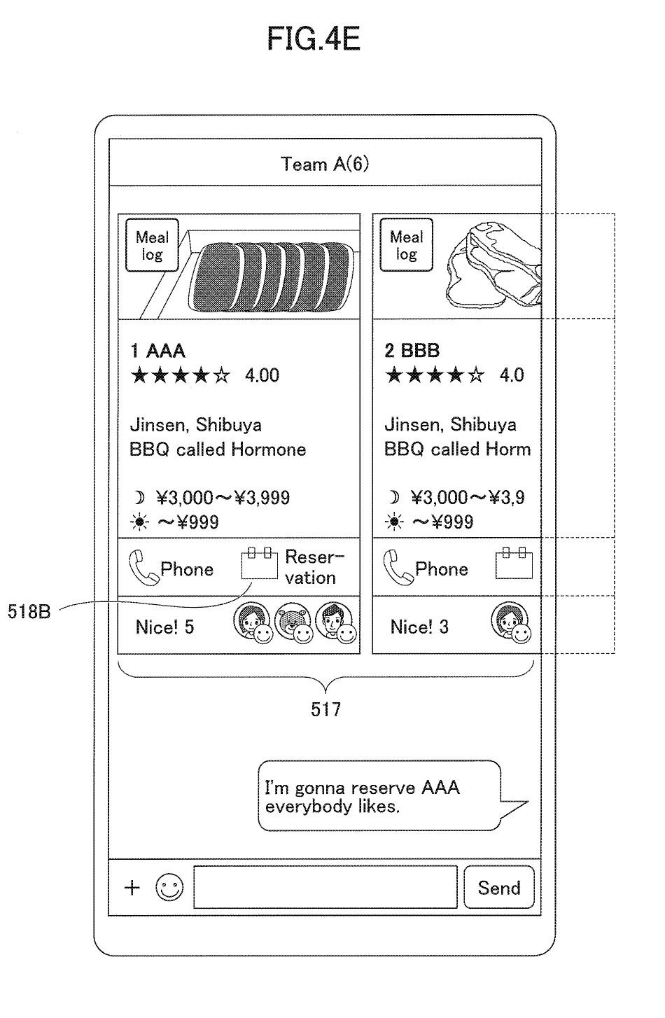

FIGS. 4A-4E are diagrams illustrating examples of display screens on the terminal 20 according to the first example embodiment.

FIG. 4A is a diagram illustrating an example of a display screen when contents are transmitted and received by using a talk room. In FIG. 4A, on the left side, icons 501A, 501B, and 501C each representing the account of the user of each terminal 20 that has transmitted a content are displayed in association with contents 502A, 502B, and 502C transmitted from the respective accounts.

At Step S202, the SNS processor 210 of the terminal 20A receives an input of a message to be transmitted from the user to the talk room.

At Step S203, the searcher 220 of the terminal 20A searches for a stamp(s) corresponding to the character string input by the user. For example, a stamp is searched that has a keyword stored in stamp information 241 of the storage device 208 that matches the character string input by the user.

Note that the stamp here is a content such as an illustration. By using a stamp, for example, it is possible to convey subtleties of emotions, which may be difficult to be expressed by words. Also, the stamp being an illustration or the like may enable to convey the purpose of the user to the counterpart at a glance.

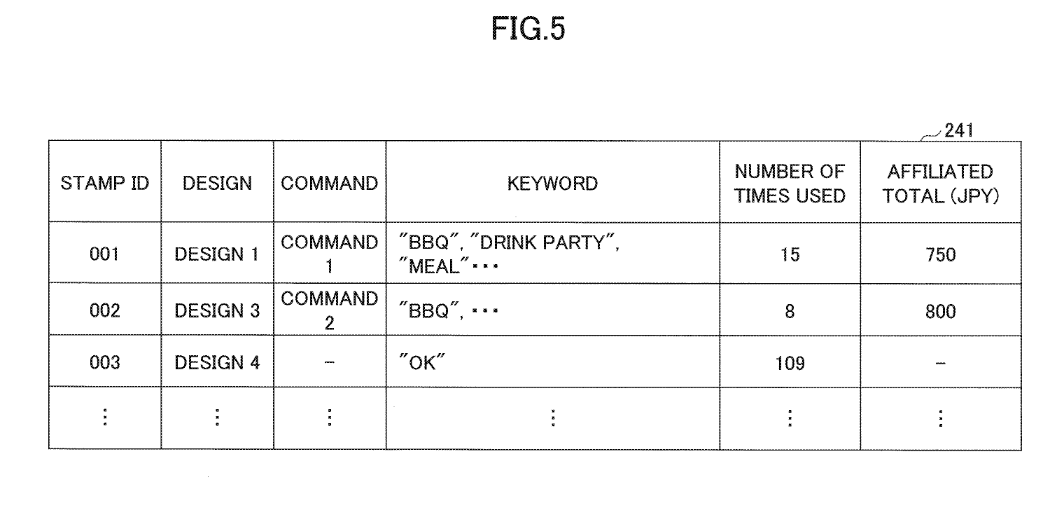

FIG. 5 is a diagram illustrating an example of the stamp information 241. In the stamp information 241 stored in the storage device 208, items of stamp ID, design, command, keyword, number of times used, and affiliated total are stored in association with each other.

The stamp ID is information for identifying a stamp.

The design is an illustration or the like of the stamp. Note that the design of a stamp having a command function (a stamp in which data corresponding to items of a command is set in the stamp information 241) may have a logo mark of a company or the like attached, so that the company or the like providing a service or a product related to the command can be recognized.

The command is a command associated with a stamp, which is, for example, a search query for searching for a service or a product. The keyword is a keyword associated with the stamp.

The number of times used is the number of times the stamp is selected by a user and transmitted to the other users in the talk room or the like. Also, the number of times used may be the number of times the user has transmitted the stamp to the other users.

The affiliated total is a total of fees (payments) paid by a company or the like that provides a service or a product related to the command associated with the stamp, due to a company of the server 10 that provides the messaging service of the SNS for the use of the stamp. For example, a unit price to be paid each time a stamp is transmitted is set in advance so as to enable to calculate the affiliated total by multiplying the unit price by the “number of times used”.

At Step S204, the SNS processor 210 of the terminal 20A displays a list of found stamps. This enables to suggest candidates of stamps to be transmitted to the user.

Here, if multiple stamps have been found, the terminal 20A may display the list in descending order of the number of times used, in descending order of the affiliated total, or in descending order of eCPM (effective Cost Per Mille). Here, “eCPM” represents the fee paid by a company or the like that provides a service or a product related to the command associated with the stamp, due to a company of the server 10 that provides the messaging service of the SNS when the stamp has been displayed for a predetermined number of times (e.g., one thousand times).

FIG. 4B is a diagram illustrating an example of a display screen of a list of stamps matching at least a part of a character string of a message input from a user to be sent to the talk room.

FIG. 4B is an example in which in an input area 511 of a message to be transmitted, “BBQ” is included at least as a part of a character string input by the user. In this case, a list of stamps for which “BBQ” is registered as a keyword in the stamp information 241 is displayed in a stamp suggestion area 512. In the example in FIG. 4B, assume that the priority is higher for an item more to the left in the stamp suggestion area 512.

At Step S205, the SNS processor 210 of the terminal 20A receives a selection operation and a transmission operation of a stamp from the user.

At Step S206, the extended function processor 230 of the terminal 20A transmits the stamp selected by the user to the talk room, and displays the design of the stamp on the screen of the talk room.

Note that this causes the design of the stamp to be displayed on the screen of the talk room also on the other terminals 20B and 20C in the talk room, similarly to the terminal 20A.

At Step S207, the extended function processor 230 of the terminal 20A displays information based on a command associated with the stamp on the screen of the talk room in chronological order. Note that on the other terminals 20B and 20C in the talk room, the information based on the command associated with the stamp is also displayed on the screen of the talk room.

FIG. 4C is a diagram illustrating an example of a display screen based on a command associated with the stamp on the screen of the talk room of the terminal 20.

In FIG. 4C, a design 513 of the stamp is displayed on the screen of the talk room. Note that the design 513 of the stamp may be the same as the design when displayed in the stamp suggestion area 512. Alternatively, it may be a design obtained, when transmitting the stamp to the talk room, from the external server 30 operated by a company or the like that provides a service or product related to the command, based on the command associated with the stamp.

Also, in FIG. 4C, based on the command associated with the stamp, a display area 514 of “BBQ” as the keyword when the stamp has been searched, a “Search around the current location” button 515, and a “Change the location” button 516 are displayed.

At Step S208, the extended function processor 230 of the terminal 20A receives an operation of specifying a search condition in a display area of the information on the screen of the talk room based on the command associated with the stamp.

At Step S209, the extended function processor 230 of the terminal 20A obtains and displays a search result corresponding to the operation specifying the search condition from the external server 30.

At Step S210, the extended function processor 230 of the terminal 20A causes the other terminals 20B and 20C in the talk room to also display the search result.

For example, the terminal 20A transmits the search result to the server 10 as a content addressed to the talk room. This causes the search result to be displayed on the screen of the talk room in the same way as contents of character string messages, stamps, images, and the like. Note that on the screen of the talk room, the transmitted and received contents are displayed, for example, in chronological order. For example, a most recently transmitted/received content may be displayed at the bottom, and previously transmitted/received contents may be sequentially moved upward.

Note that it is possible for the other terminals 20B and 20C in the talk room to execute the process at Steps S208 to S210, similarly to the terminal 20A that has transmitted the stamp. In other words, a search result corresponding to an operation on the other terminal in the talk room, namely, 20B and/or 20C is also displayed on the terminal 20A.

This enables the users to advance the process of searching and the like while communicating with each other through messages in the talk room.

FIG. 4D is a diagram illustrating an example of a display screen of a search result when the “Search around the current location” button 515 in FIG. 4C has been pressed.

In FIG. 4D, a list of restaurants that have been found under conditions of the category of “BBQ” and the area of “the current location” is displayed in a carousel area 517, which is obtained from the external server 30 operated by a company or the like that provides a service or a product related to the command. Note that the information displayed in FIG. 4C has been moved upward on the screen of the talk room in FIG. 4D. This is substantially the same process as on the screen of a conventional talk room, which moves upward older contents among those that have been transmitted and received. By scrolling the screen of the talk room downward, it is possible to display the information displayed in FIG. 4C.

The carousel area 517 is displayed and scrolled in the horizontal direction automatically or in response to a swipe operation performed by the user. By clicking on the “Nice!” button 518, the popularity poll of the restaurants may be enabled.

FIG. 4E is a diagram illustrating an example of a display screen when the user of the terminal 20A in the talk room transmits a message to another user in the talk room.

FIG. 4E is a diagram illustrating an example of a display screen when the user of the terminal 20A selects a restaurant to use from the list of restaurants displayed in the carousel area 517 and indicates the restaurant to the other users.

The process of transmitting the message to the other users in the talk room is the same as a process in a messaging service of a conventional SNS.

At Step S211, the extended function processor 230 of the terminal 20A activates an IAB (in-application browser) in response to an operation performed by the user, and issues an execution request to the external server 30. Note that the IAB is a function that uses a browser function provided by the OS of the terminal 20 in an application installed on the terminal 20. In the example embodiment, a browser function is used in an application that executes the SNS messaging service installed on the terminal 20.

Note that, similarly to the terminal 20A that has transmitted the stamp, it is possible for the other terminals 20B and 20C in the talk room to execute the process at Step S211.

This enables the users to advance the process of purchasing a product, reserving a service, or the like by using search results obtained by operations of multiple users, while communicating with each other through messages in the talk room.

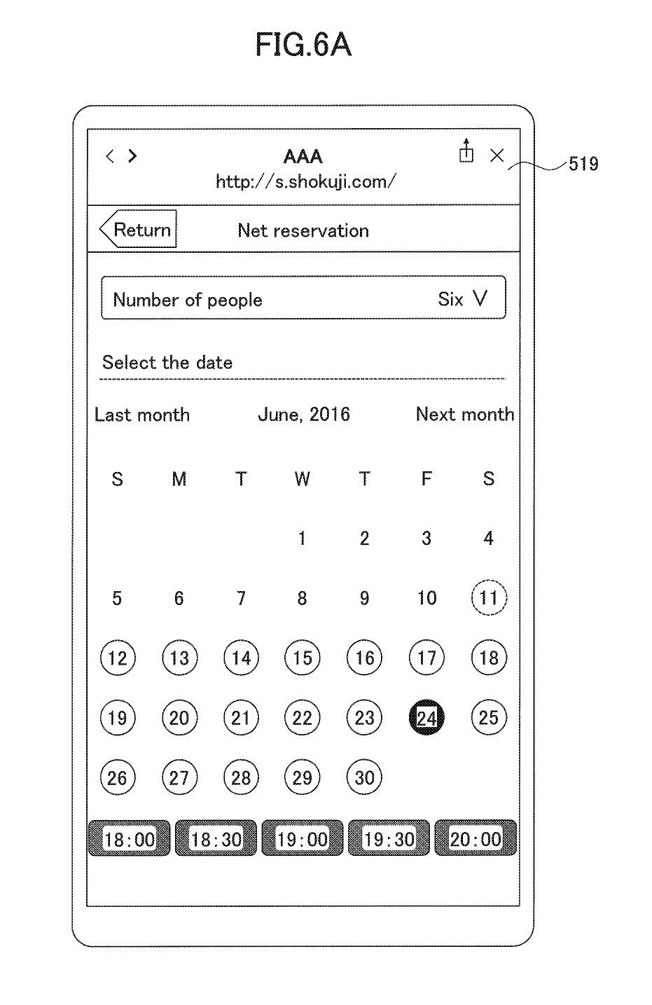

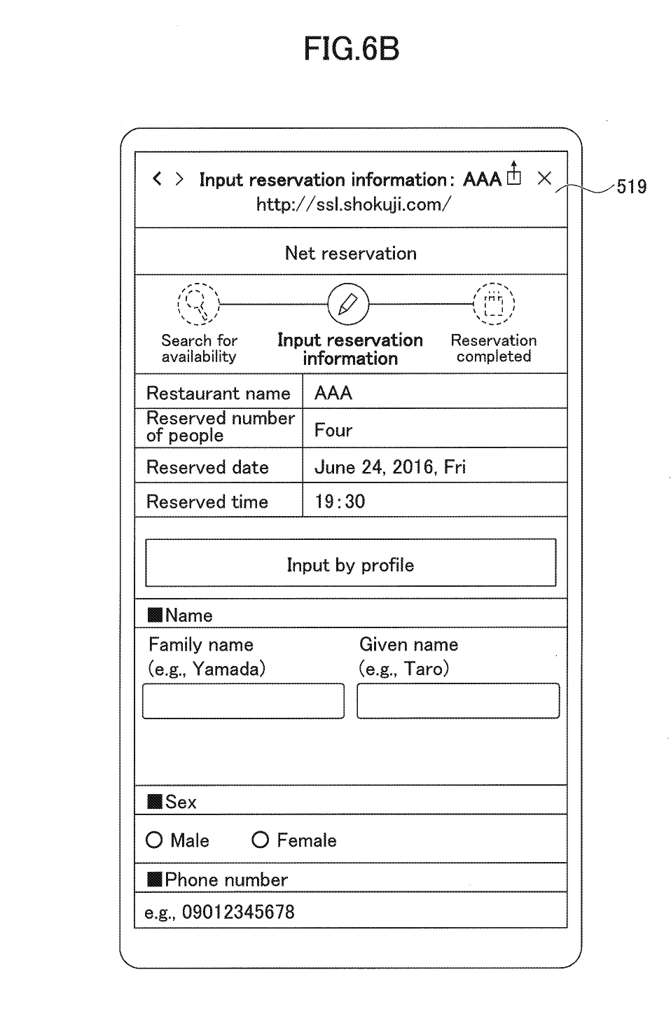

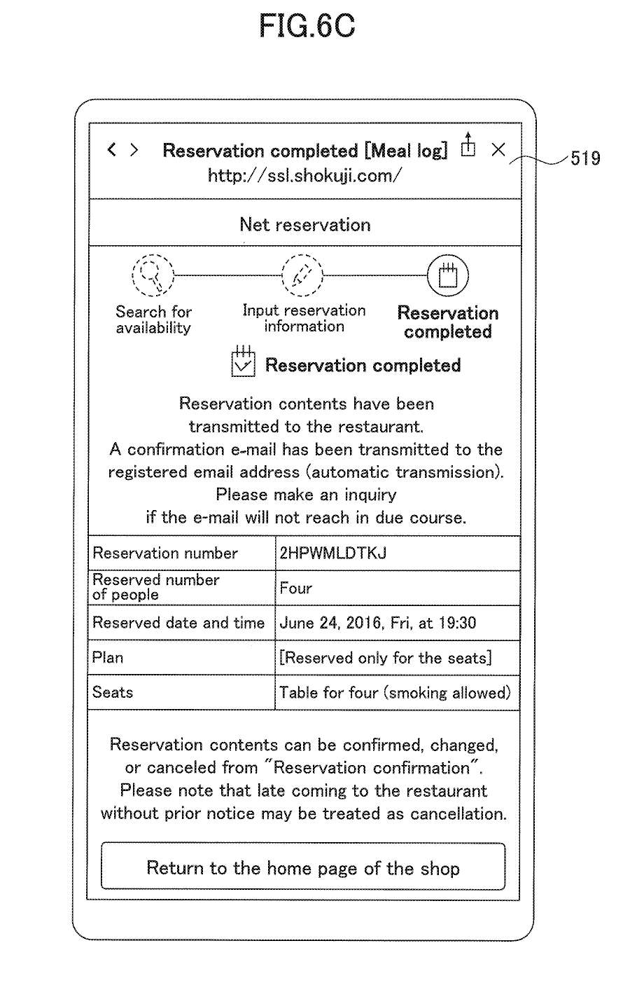

FIGS. 6A-6C are diagrams illustrating examples of display screens of a Web site of the external server 30, on the terminal 20 according to the first example embodiment.

For example, when a “Reservation” button 518B in FIG. 4E is pressed by the user, the IAB is activated to access the Web site of the external server 30 and a screen is displayed as in FIG. 6A. Note that the server 10 and the external server 30 may interoperate so as to automatically log in to the external server 30 by using the login information of the account of the user of the terminal 20 in the server 10. In the example in FIG. 6A, the number of people and the date are selected when reserving a restaurant.

In FIG. 6B, for example, after the input on the screen in FIG. 6A has been completed, user information of the terminal 20 is input. Note that the server 10 and the external server 30 may interoperate so as to automatically input the user information in FIG. 6B by using the personal information of the account of the user of the terminal 20 in the server 10.

FIG. 6C illustrates a display of information when a reservation has been completed. When an “x” button 519 in FIG. 6C is pressed by the user, the screen returns to the screen of the talk room.

At Step S212, the extended function processor 230 of the terminal 20A displays a result of the execution request received from the external server 30.

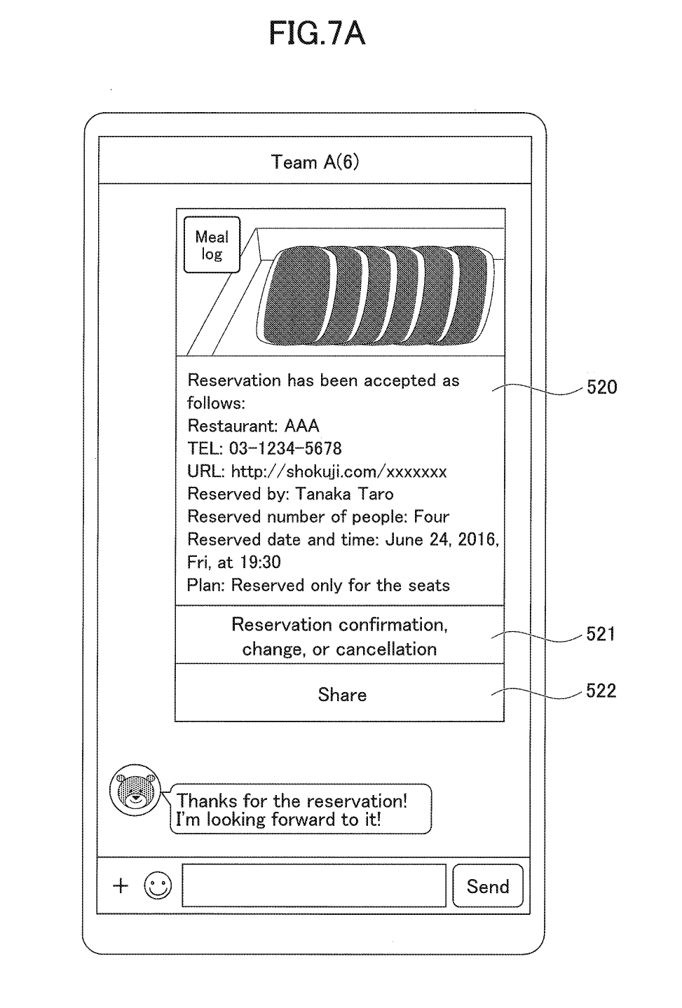

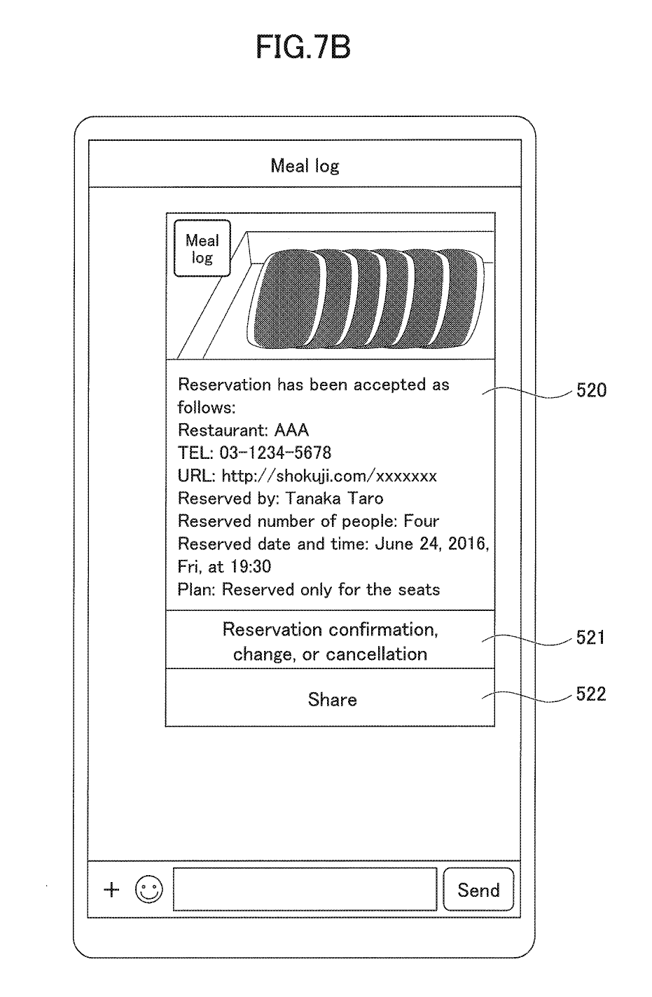

FIGS. 7A-7B are diagrams illustrating examples of display screens of a result of an execution request on the terminal 20 according to the first example embodiment.

FIG. 7A is an example of a display screen of a result of an execution request which is addressed to and received by the talk room.

When receiving the same execution request from the same talk room within a certain time (e.g., 10 seconds), the external server 30 or the server 10 may execute a process only for one execution request. This enables to prevent the same execution result from being displayed multiple times, for example, when multiple users have executed the same operation in the talk room.

In FIG. 7A, a result of restaurant reservation 520 and the like are displayed. When a “Reservation confirmation, change, or cancellation” button 521 is pressed, for example, the IAB is activated so as to enable the user to access the Web site of the external server 30, and to confirm the reservation and the like. When a “Share” button 522 is pressed, for example, the result of restaurant reservation 520 is shared with another talk group selected by the user.

FIG. 7B is an example of a display screen of a result of an execution request addressed to and received on the account of the user of the terminal 20 on which the user has made the execution request.

For example, if the account of the user of the terminal 20A follows an account of a company or the like of the external server 30 in the SNS messaging service provided on the server 10, the execution result may be received from the account of the company or the like.

### First Modified Example

When a stamp received from the terminal 20A is not stored in the stamp information 241 of the storage device 208 of the terminal 20B, the terminal 20B may gray out and display the design of the stamp on the screen of the talk room. Then, when the user selects the stamp by a click operation or the like on the screen of the talk room, the terminal 20B displays information such as the account name of the user of the terminal 20A who has transmitted the stamp.

### Second Modified Example

In a second modified example, each of the terminal 20A, the terminal 20B, and the terminal 20C independently obtains a search result corresponding to an operation on each of the terminals from the external server 30.

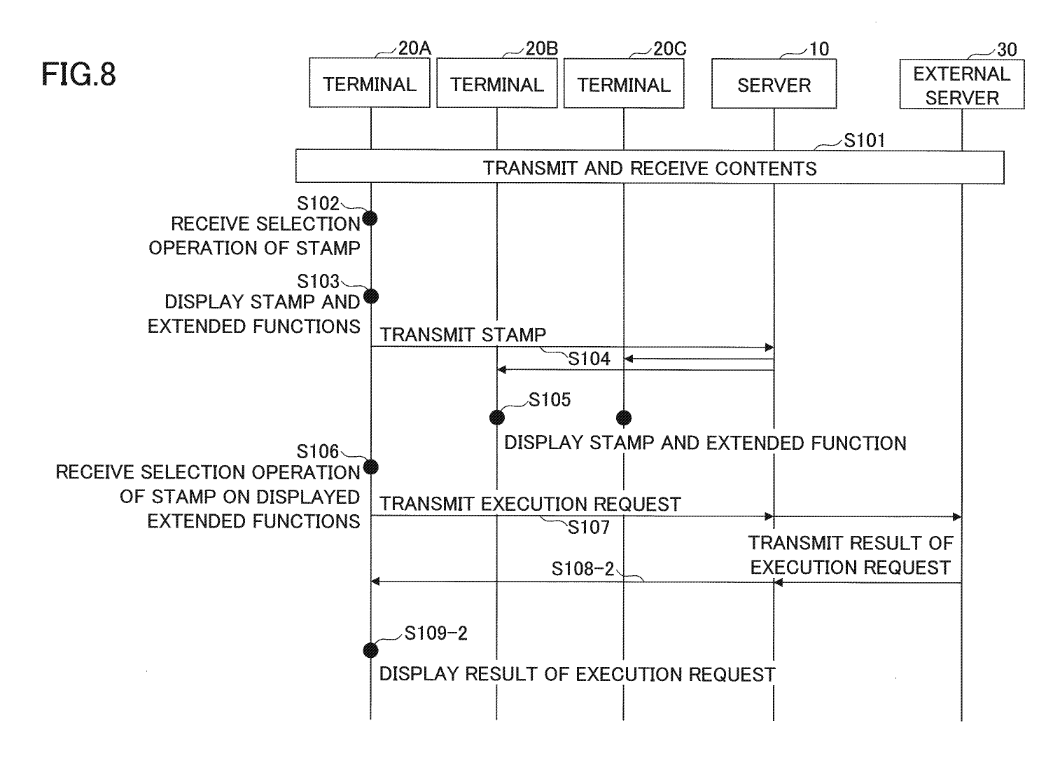

With reference to FIG. 8, a process in the communication system 1 will be described according to the second modified example of the first example embodiment. FIG. 8 is a diagram illustrating an example of a sequence of the process in the communication system 1 according to the second modified example of the first example embodiment.

The process at Steps S101 to S107 in FIG. 8 is substantially the same as the process at Step S101 to S107 in FIG. 2.

At Step S108-2, the external server 30 transmits a result of an execution request to the terminal 20A via the server 10.

At Step S109-2, the extended function processor 230 of the terminal 20A displays the result of the execution request received from the external server 30 via the server 10.

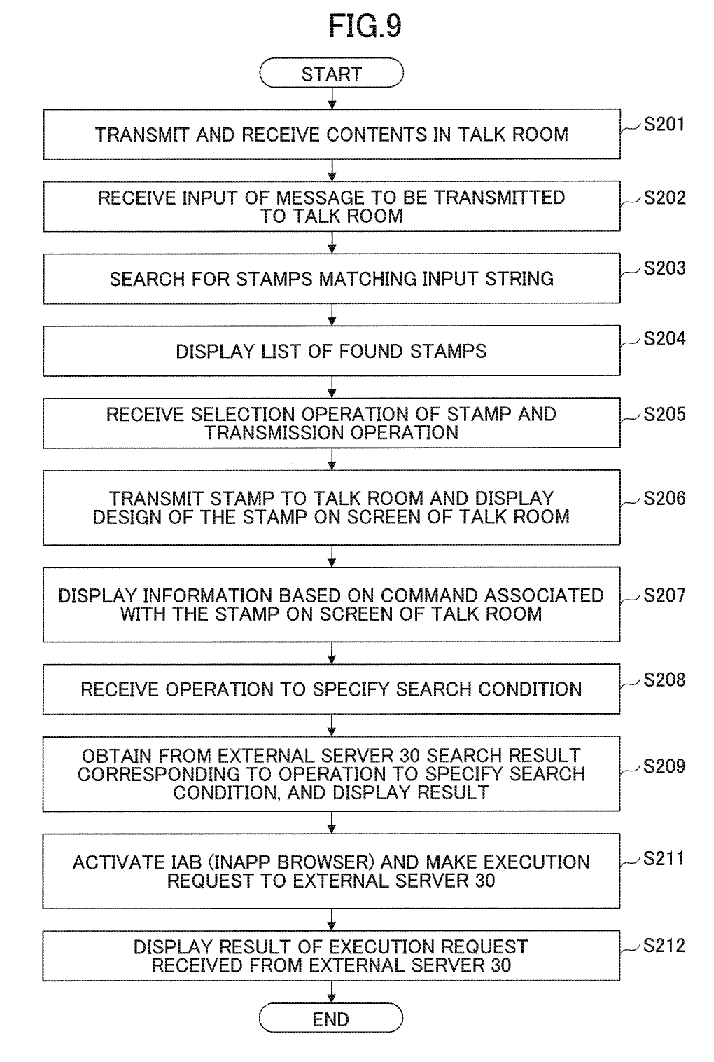

FIG. 9 is a flowchart illustrating an example of a process of the terminal 20A according to the second modified example of the first example embodiment.

The process at Step S201 to S209 in FIG. 9 is substantially the same as the process at Step S201 to Step S209 in FIG. 3.

At Step S209, the extended function processor 230 of the terminal 20A obtains a search result corresponding to an operation specifying a search condition from the external server 30 and displays the result on the screen of the terminal 20A.

Here, in the second modified example, the process at Step S210 in FIG. 3 is not executed. In other words, the search result obtained from the external server 30 is not transmitted to the other terminals 20B and 20C in the talk room.

Note that it is also possible for the other terminals 20B and 20C in the talk room to execute the process at Steps S208 to S209 in substantially the same way as executed on the terminal 20A that has transmitted the stamp. In other words, a search result corresponding to an operation on the other terminal 20B and/or the terminal 20C in the talk room is not displayed on the terminal 20A.

This enables the user to enjoy convenience of excluding information other than information the user wants, or of preventing unwanted information from another terminal from being displayed on the screen of the talk room.

### Second Example Embodiment

Next, a second example embodiment will be described.

In the second example embodiment, an example will be described in which in a talk room of a messaging service of an SNS that executes communication among multiple specific users, multiple users make payment of a fee after having purchased a product or a service searched by using a stamp. This enables multiple users to make payment of a fee after having searched for products or services while trying to communicate in a group including the multiple users. Note that since the second example embodiment is similar to the first example embodiment except for some parts, the description of such parts may be omitted when appropriate.

In the following, details of a process in the communication system 1 according to the second example embodiment will be described with respect to differences from the first example embodiment.

Note that the contents described in the second example embodiment can be applied to any of the other example embodiments.

<Process>

<Process on Terminal 20>

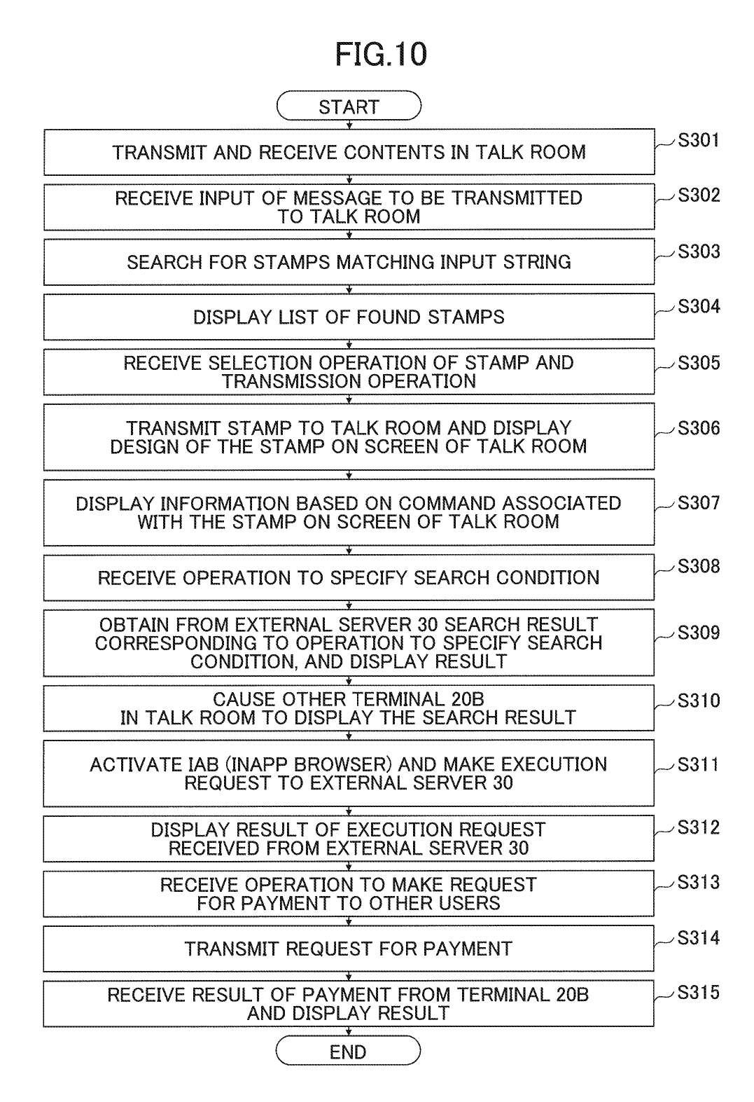

Next, with reference to FIG. 10, a process of the terminal 20A according to the second example embodiment will be described. FIG. 10 is a flowchart illustrating an example of a process of the terminal 20A according to the second example embodiment.

The process at Steps S301 to S307 is substantially the same as the process at Steps S201 to S207.

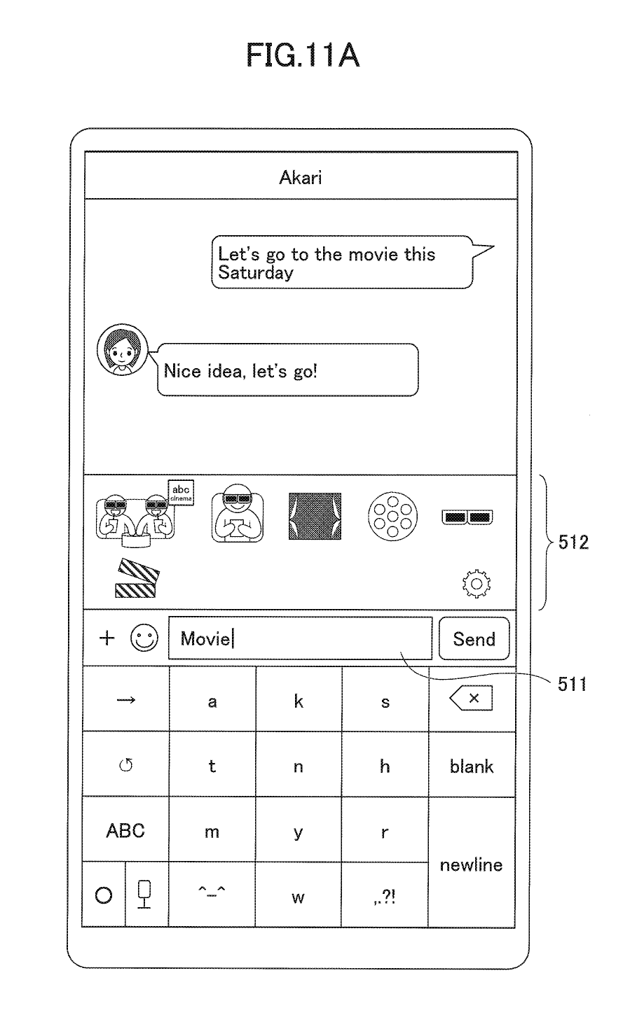

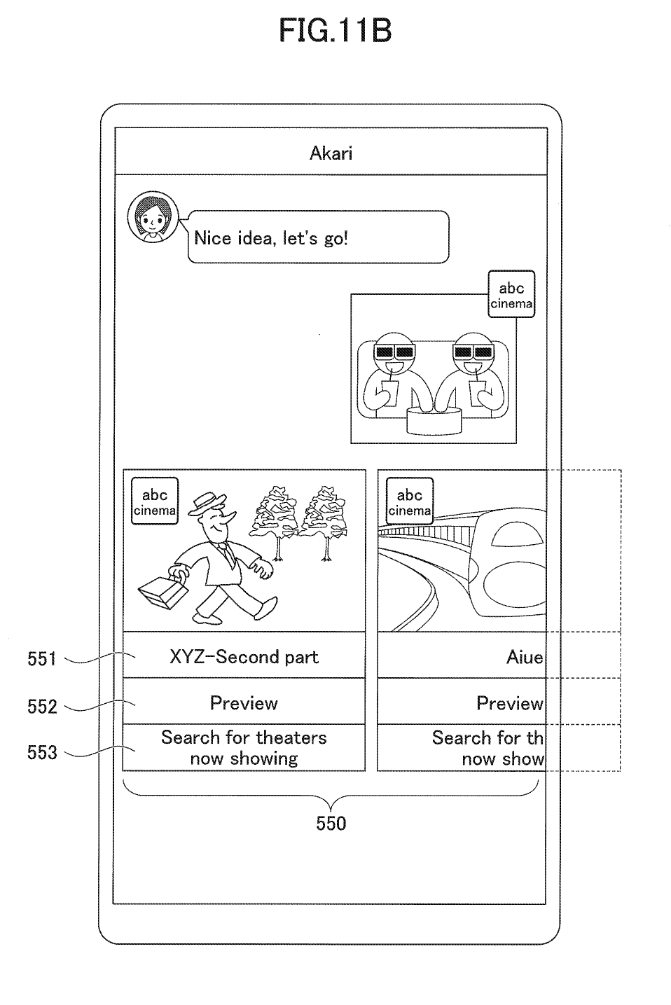

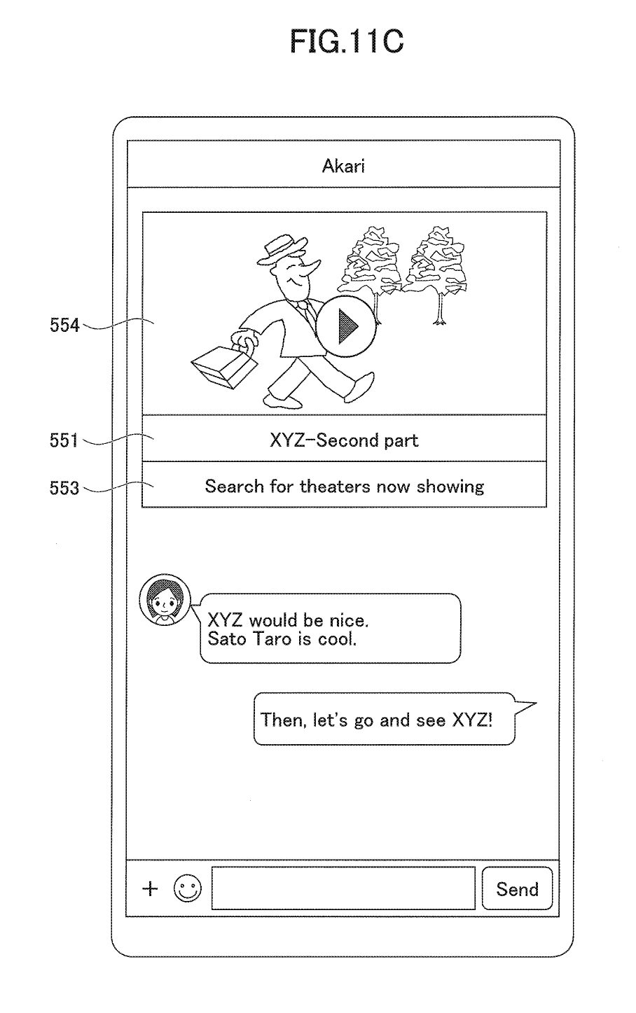

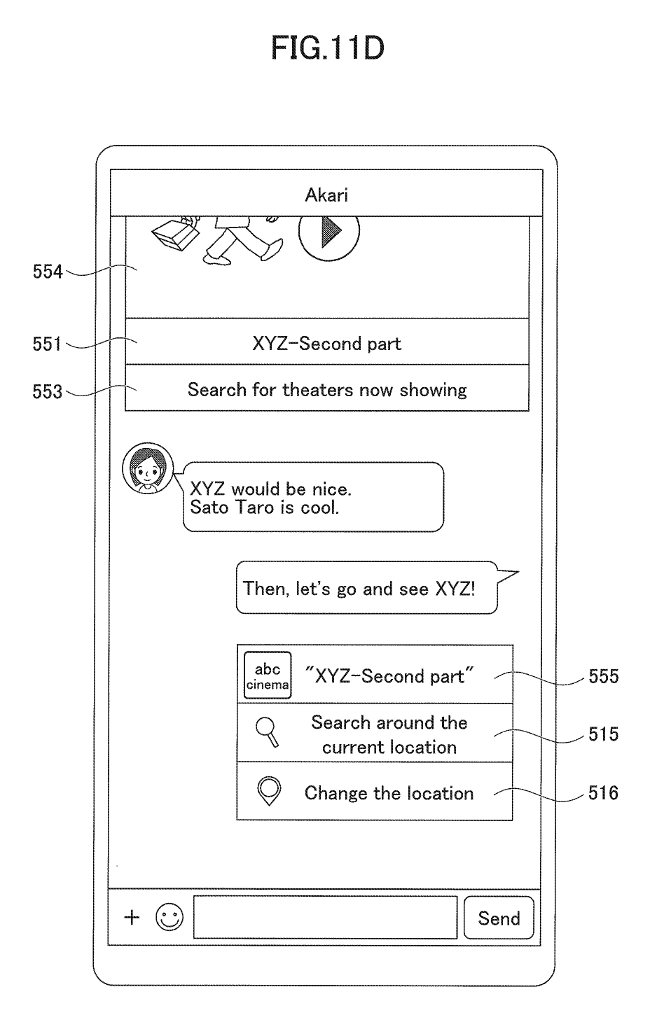

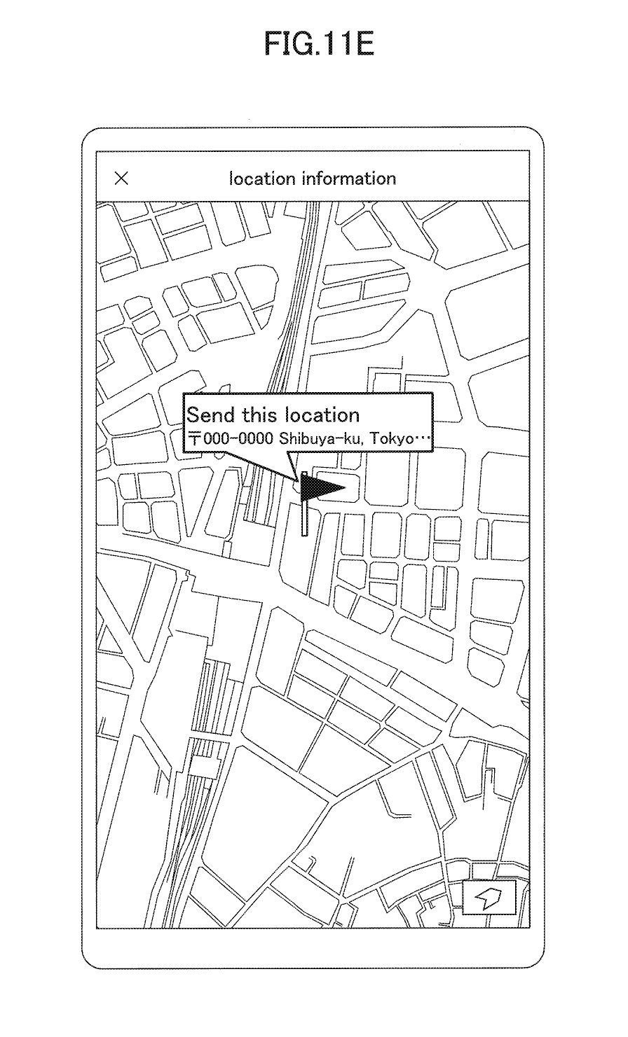

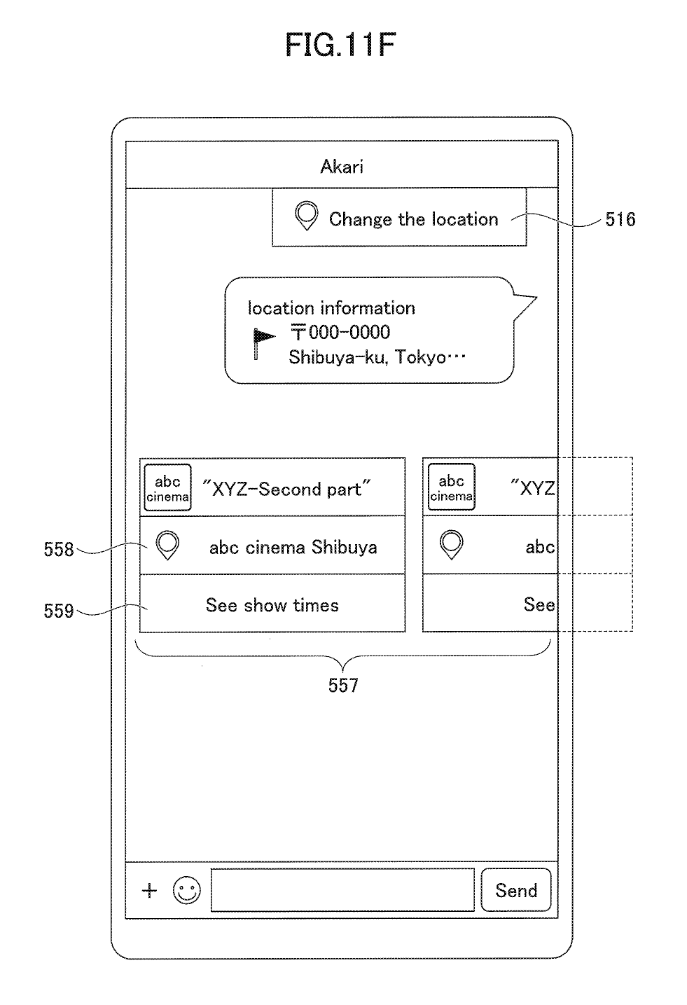

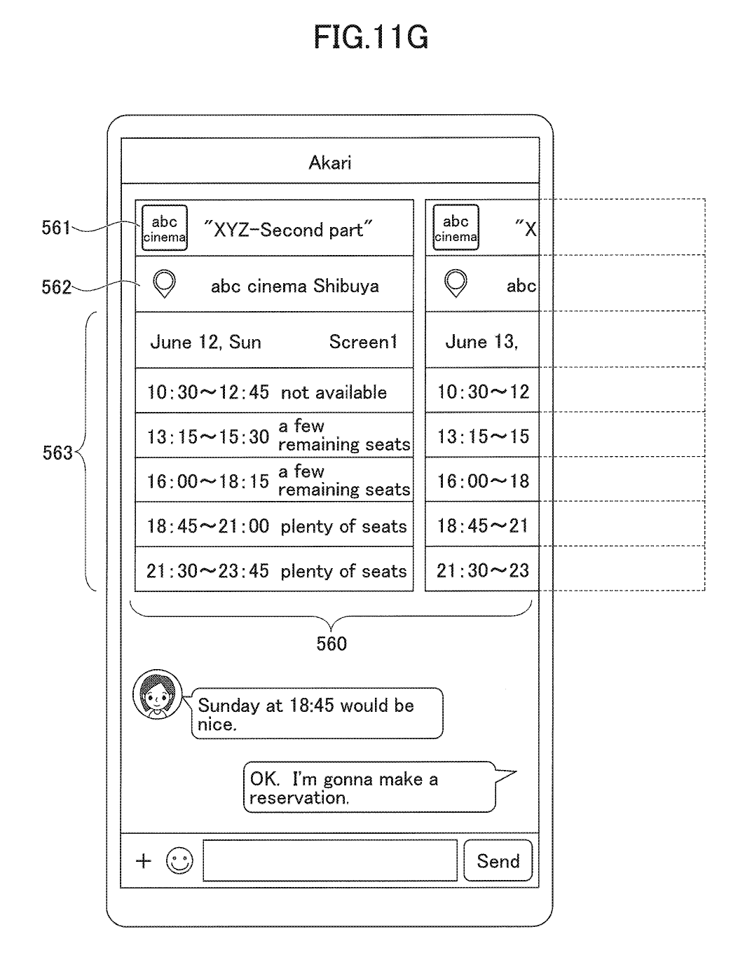

FIGS. 11A-11G are diagrams illustrating examples of display screens on the terminal 20 according to the second example embodiment.

FIG. 11A illustrates an example of a display screen of a list of stamps matching at least a part of a character string of a message to be transmitted to a talk room, which is input by the user while transmitting and receiving contents by using the talk room.

In FIG. 11A, “Movie” is included in at least a part of a character string input by the user in an input area 511 of a message to be transmitted. In this case, a list of stamps in which “movie” is registered as a keyword in the stamp information 241 is displayed in a stamp suggestion area 512.

FIG. 11B is a diagram illustrating an example of a display screen based on a command associated with a stamp on the screen of the talk room of the terminal 20.

In FIG. 11B, a list of movies is displayed in a carousel area 550, based on commands associated with the respective stamps. In this carousel area 550, movie name display areas 551, “Preview” buttons 552, and “Search for theaters now showing” buttons 553 are displayed.

In FIG. 11C, one of the “Preview” buttons 552 in FIG. 11B has been pressed by the user of the terminal 20A, to play back a video of a preview version of the movie in a display area 554. The data of the video may be obtained, for example, from the external server 30.

At Step S308, the extended function processor 230 of the terminal 20A receives an operation of specifying a search condition in a display area of information based on a command associated with the stamp on the screen of the talk room.

In FIG. 11D, if the “Search for theaters now showing” button 553 is pressed, a movie name display area 554, a “Search around the current location” button 515, and a “Change the location” button 516 are displayed.

If the “Change the location” button 516 is pressed, as illustrated in FIG. 11E, a location to be searched around on a map can be designated.

At Step S309, the extended function processor 230 of the terminal 20A obtains a search result corresponding to the operation specifying the search condition from the external server 30 and displays the result.

In FIG. 11F, as the search result, a list of movie theaters around the designated location is displayed in a carousel area 557. In this carousel area 557, theater name display areas 558 and “See showtimes” buttons 559 are displayed.

At Step S310, the extended function processor 230 of the terminal 20A causes the other terminals 20B and the like in the talk room to also display the search result.

If one of the “See showtimes” buttons 559 in FIG. 11F has been pressed on the search result, then, as illustrated in FIG. 11G, in a carousel area 560, a movie name display area 561, a theater name display area 562, and a showtime schedule display area 563 are displayed.

At Step S311, the extended function processor 230 of the terminal 20A activates the IAB (in-application browser) in response to an operation performed by the user to issue an execution request to the external server 30.

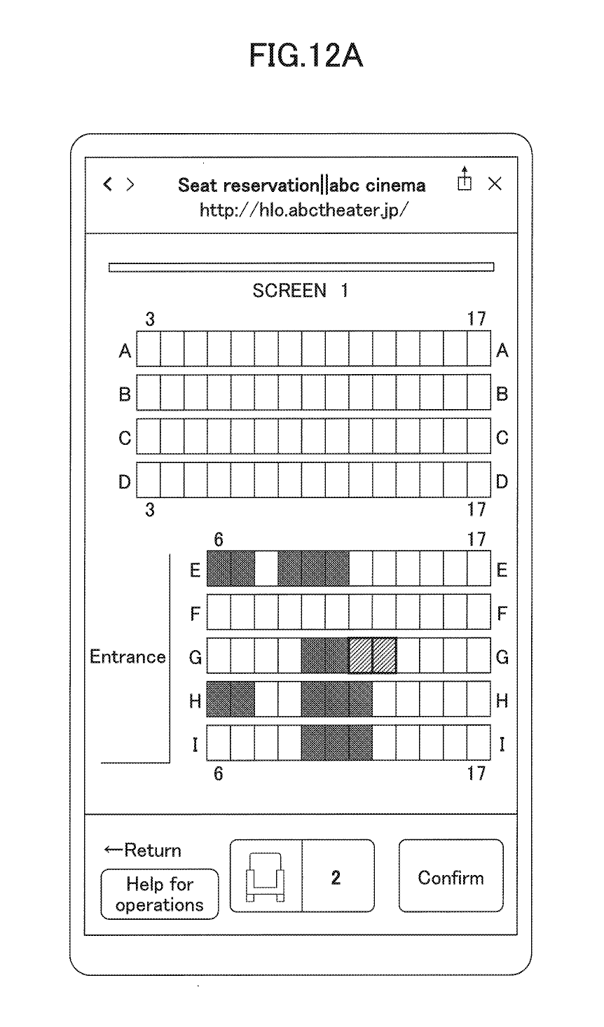

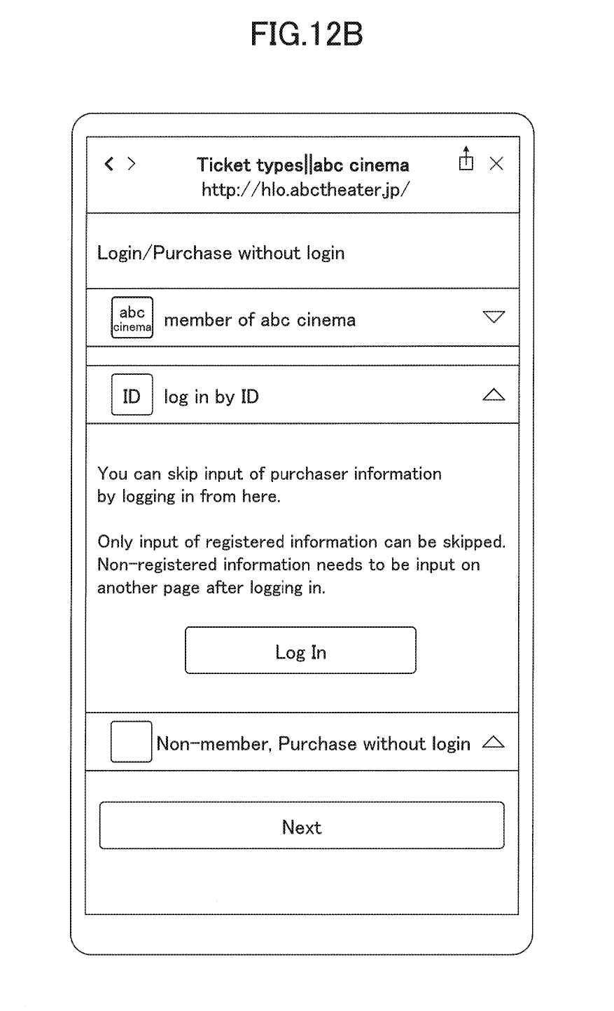

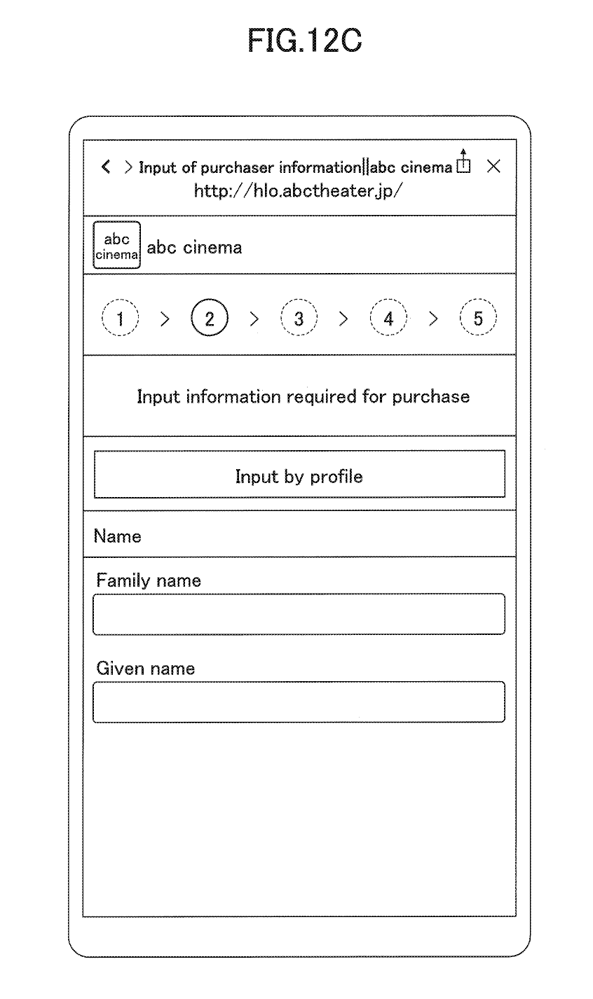

FIGS. 12A to 12C are diagrams illustrating examples of display screens of a Web site of the external server 30 displayed on the terminal 20 according to the second example embodiment.

For example, in FIG. 11G, if a certain showtime has been selected, the IAB is activated to access a Web site of the external server 30, and to display a screen as illustrated in FIG. 12A.

In the example in FIG. 12A, one or more seat positions in the movie theater may be selected.

In FIG. 12B, for example, after completing the input on the screen of FIG. 12A, the user is prompted to select whether or not to automatically log in to the external server 30 by using the login information of the account of the user of the terminal 20 in the server 10.

In FIG. 12C, after having logged in to the external server 30, the user information of the terminal 20 is input. Note that as in the first example embodiment, the server 10 and the external server 30 may interoperate so as to automatically input the user information by using the personal information of the account of the user of the terminal 20 in the server 10.

At Step S312, the extended function processor 230 of the terminal 20A displays a result of the execution request received from the external server 30.

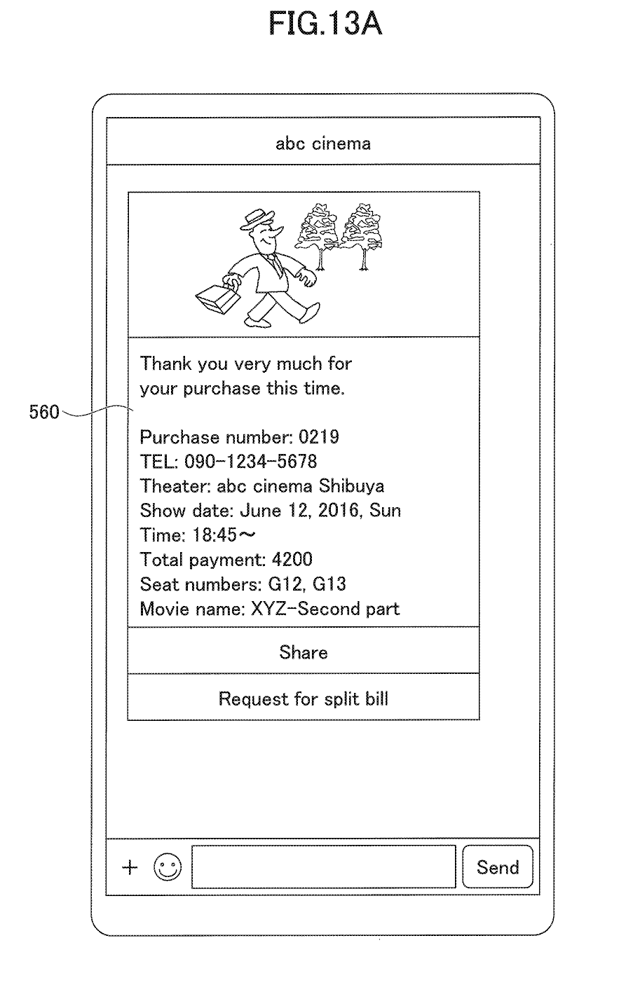

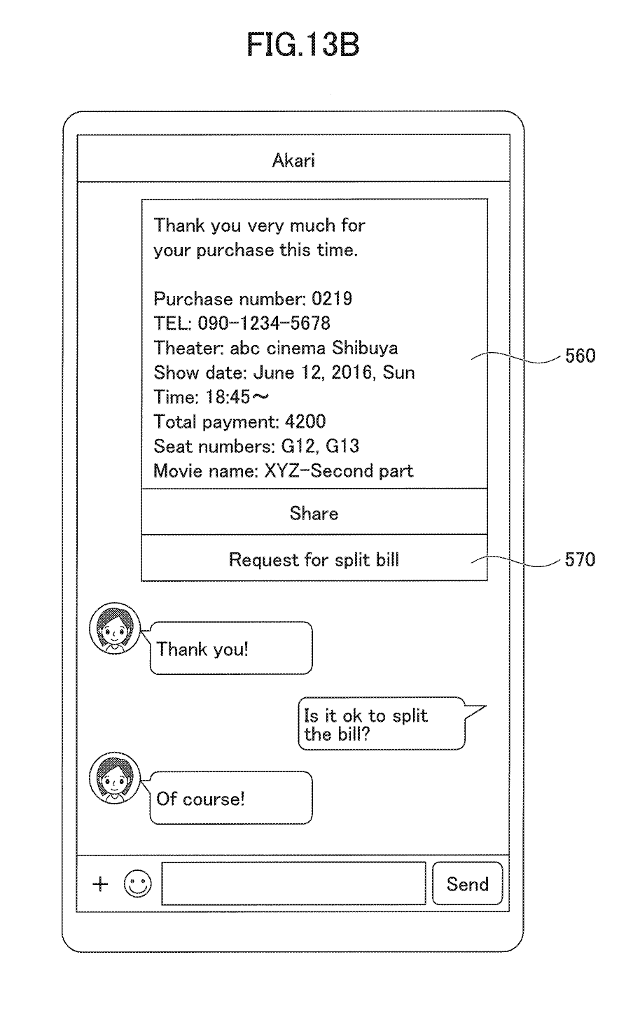

FIGS. 13A-13B are diagrams illustrating examples of display screens of a result of an execution request on the terminal 20 according to the second example embodiment.

FIGS. 13A and 13B are examples of display screens of a result of an execution request addressed to and received by the talk room.

At Step S313, the SNS processor 210 of the terminal 20A receives a payment request operation of at least a part of a fee from the user to the other users included in the talk room by using a settlement service of the server 10.

At Step S314, the SNS processor 210 of the terminal 20A transmits the payment request to the server 10.

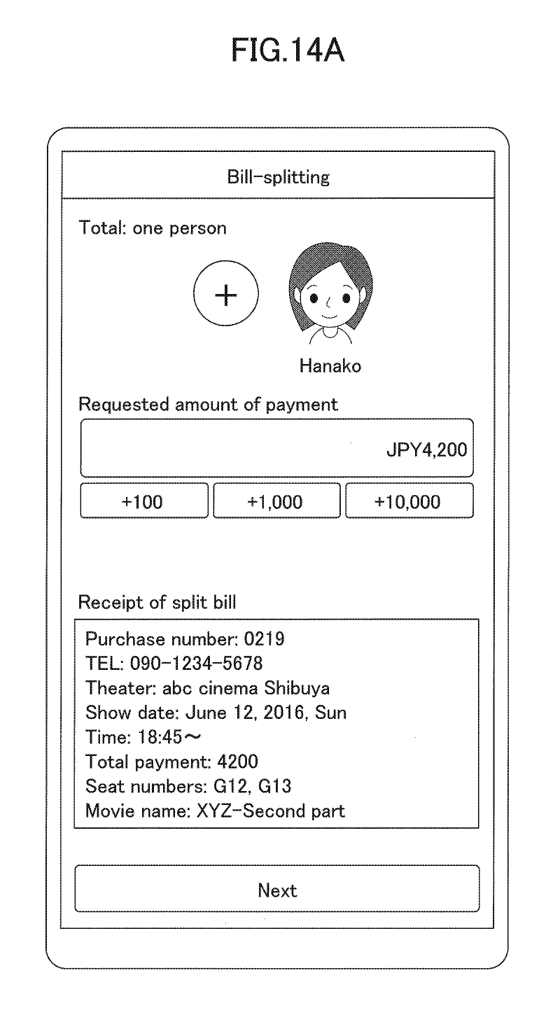

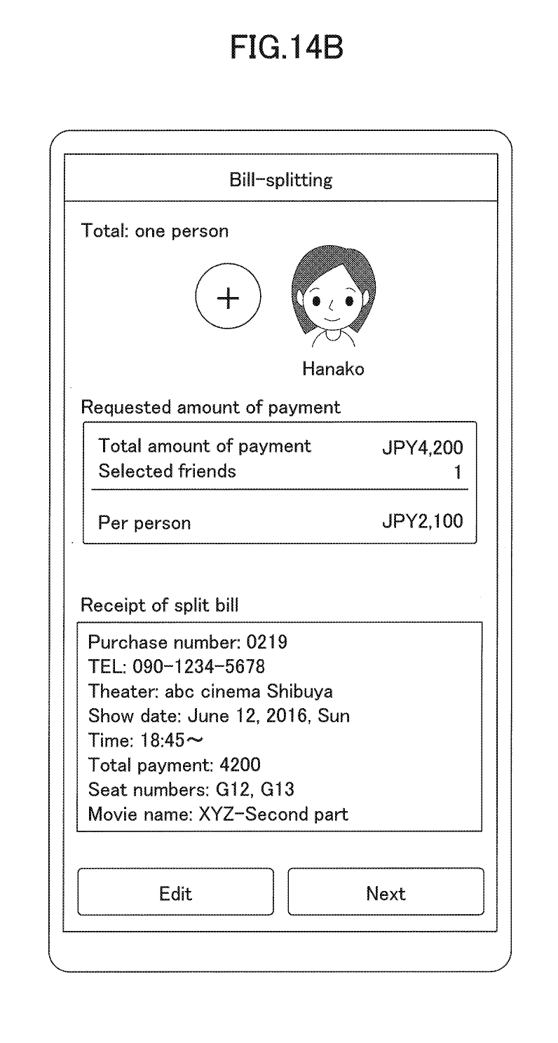

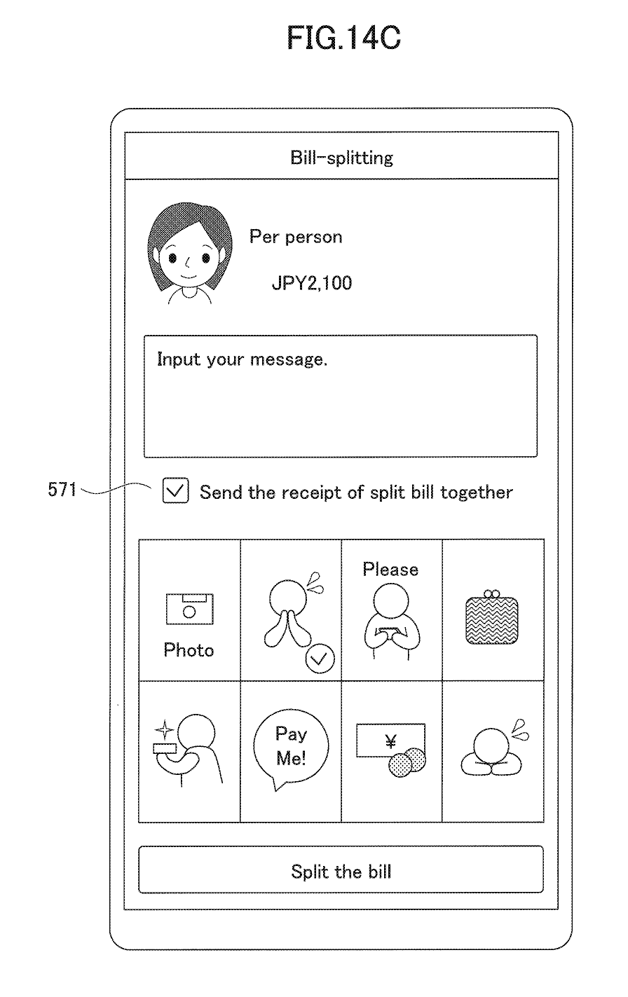

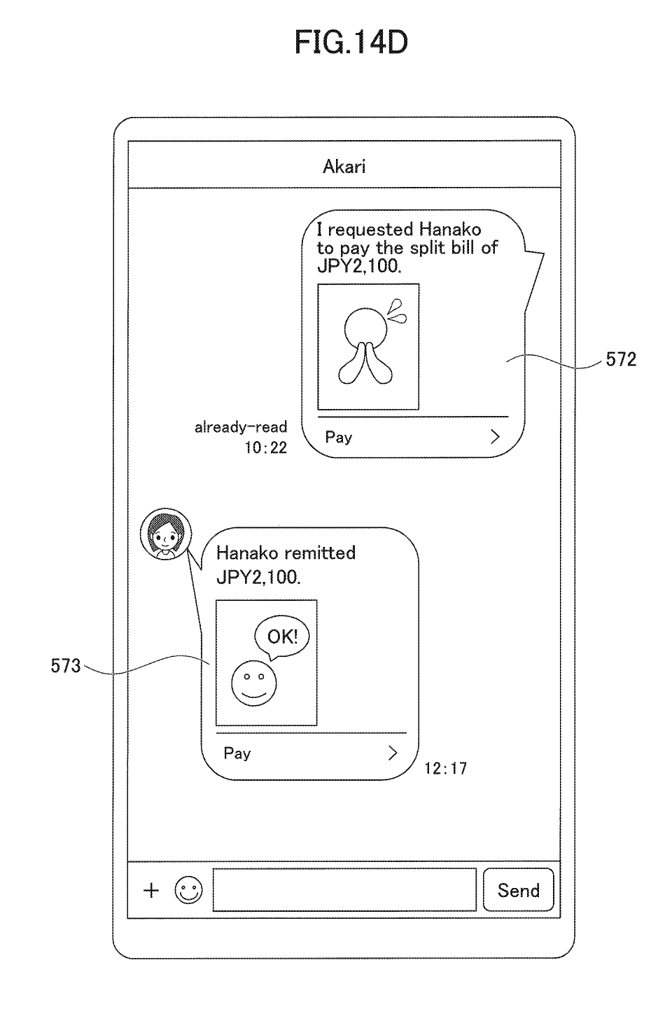

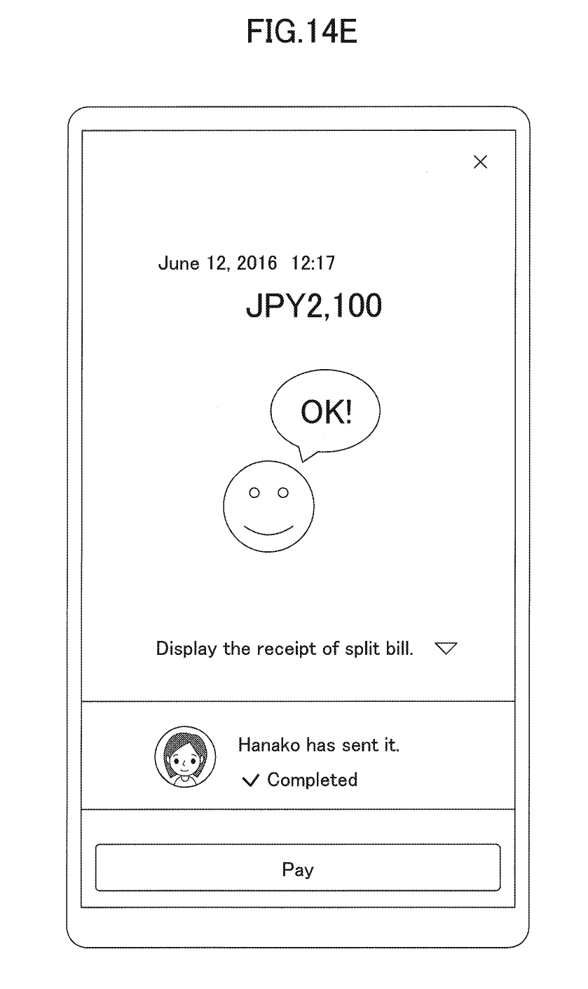

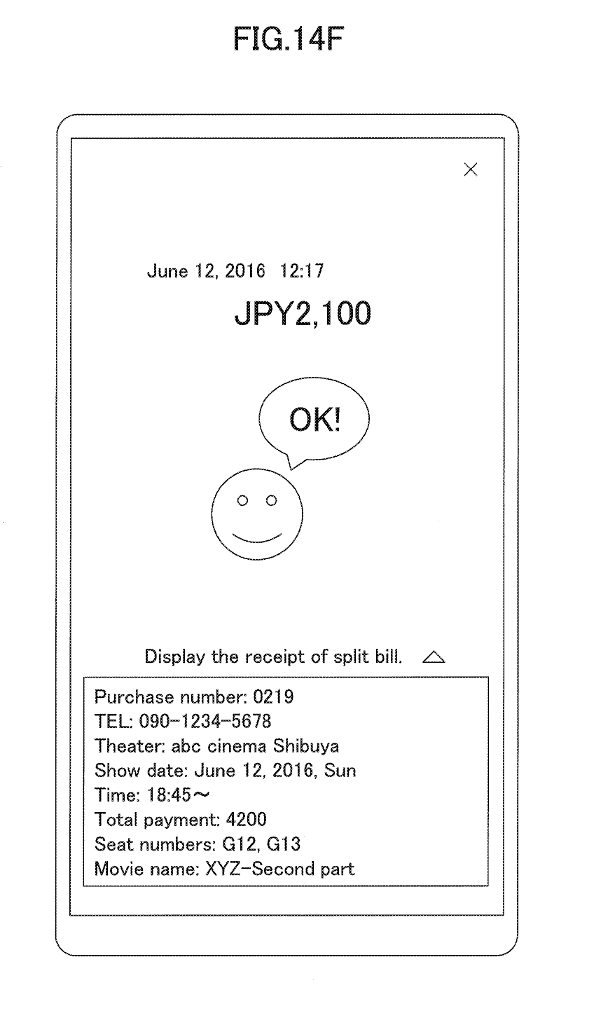

For example, when a “Request for split bill” button 570 in FIG. 13A or 13B is pressed, a screen as illustrated in FIG. 14A is displayed.

FIGS. 14A-14F are examples of display screens on the terminal 20A when receiving a payment request operation.

In FIG. 14A, information such as an amount that has been paid, a service that has been purchased, and the like are displayed. In FIG. 14B, a payment amount per each of the other users included in the talk room is displayed. In the example in FIG. 14B, since the user of the terminal 20A has completed the payment through a process using the IAB, if there is only one person to be involved in the bill-splitting, the amount obtained by dividing the payment amount by 2 is calculated as the split bill amount.

In FIG. 14C, when transmitting the payment request to the talk room, it is possible to select a message or a stamp to be transmitted together. Also, selecting a “Send the receipt of split bill together” button 571 enables the counterpart to refer to the receipt.

At Step S315, the SNS processor 210 of the terminal 20A receives a payment result from the terminal 20B and displays the result.

In FIG. 14D, a message and a stamp are displayed that correspond to a payment request 572 to the user of the terminal 20B, and a notice 573 indicating that the payment by the user of the terminal 20B has been completed, respectively.

FIG. 14E illustrates a display example when the notice 573 indicating completion of the payment has been clicked.

FIG. 14F illustrates a display example of the receipt of the split bill.

### Modified Example

In a modified example, each of the terminal 20A, the terminal 20B, and the terminal 20C independently obtains a search result corresponding to an operation on each of the terminals from the external server 30.

A diagram illustrating an example of a sequence of a process in a communication system 1 according to the modified example of the second example embodiment may be the same as the diagram of FIG. 8 illustrating an example of a sequence of a process in the communication system 1 according to the second modified example of the first example embodiment.

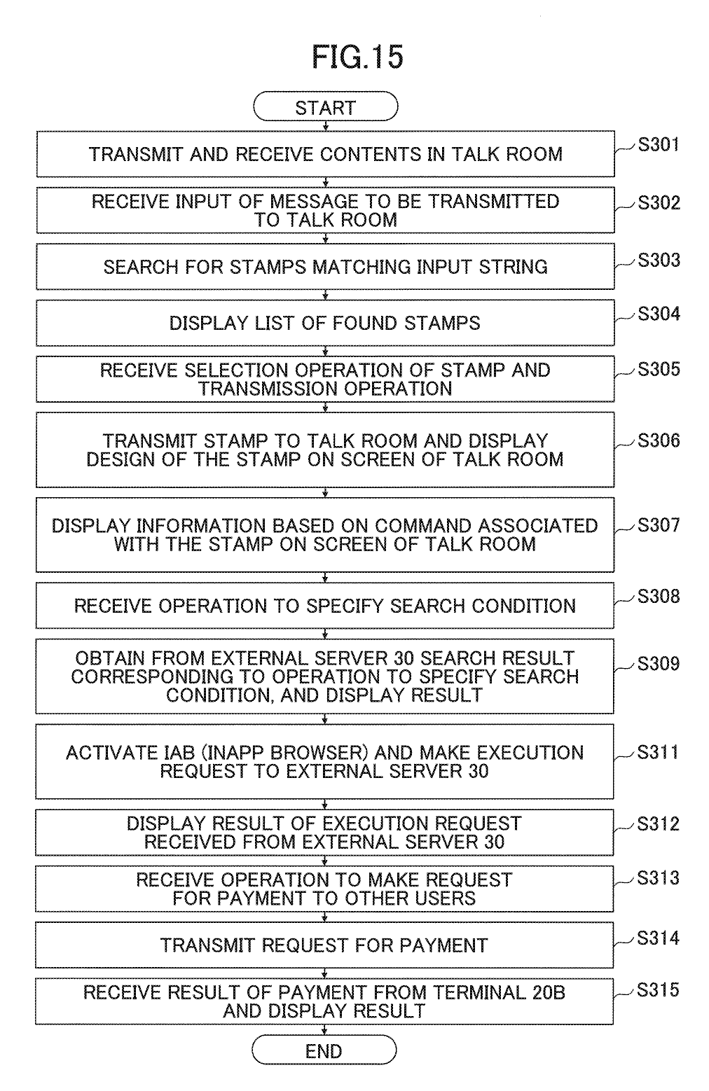

FIG. 15 is a flowchart illustrating an example of a process of the terminal 20A according to the modified example of the second example embodiment.

The process at Steps S301 to S309 in FIG. 15 is substantially the same as the process at Steps S301 to S309 in FIG. 10.

At Step S309, the extended function processor 230 of the terminal 20A obtains a search result in response to an operation that specifies a search condition from the external server 30 and displays the result on the screen of the terminal 20A.

Here, in the modified example of the second example embodiment, the process at Step S310 in FIG. 10 is not executed. In other words, the search result obtained from the external server 30 is not transmitted to the other terminals 20B and 20C in the talk room.

Note that it is also possible for the other terminals 20B and 20C in the talk room to execute the process at Steps S308 to S309 similarly to the terminal 20A that has transmitted the stamp. In other words, a search result in response to an operation on the other terminal 20B or the terminal 20C in the talk room is not displayed on the terminal 20A.

This enables the user to enjoy convenience of excluding information other than information the user wants, or of preventing unwanted information from another terminal from being displayed on the screen of the talk room.

<Summary>

According to the example embodiment, a stamp having a command (search query) function is displayed as a suggestion to the user, search information required in a conversation in a group of multiple users is directly displayed in the talk room, and a task such as a payment is processed by the IAB.

This enables to search for products and services while performing communication in a group including the multiple users.

Note that the command of the extended function associated with a stamp may be anything. The command may be a reservation, search, etc. for a product or service among, for example, restaurant reservation, movie theater reservation, recipe search, delivery order, ticket purchase, car rental reservation, hotel reservation, airline ticket purchase, weather forecast, transit guide, news, fortune telling, cartoon, music, part-time job, scheduling, and the like.

<Other>

The SNS processor 210 is an example of at least one processor configured to execute transmitting an object to another information processing terminal; and the extended function processor 230 is an example of said at least one processor configured to execute displaying on the screen of the talk room an extended function corresponding to the object in chronological order in the talk room as a content in the talk room.

A non-transitory computer-readable recording medium storing a program code of software that implements functions of an example embodiment described above may be supplied to the terminal 20 and the server 10. Furthermore, it is needless to say that an example embodiment described above is implemented by the terminal 20 and the server 10 that read the program code stored in the recording medium, and execute the program code. In this case, a program that causes the terminal 20 and the server 10 to execute an information processing method described above is stored in the recording medium.

At least a part of the processes executed on the terminal 20 and the server 10 may be implemented by cloud computing constituted with one or more computers.

Also, at least a part of the processes executed on the terminal 20 may be executed on the server 10. For example, the extended function processor 230 of the terminal 20 may be provided on the server 10 side, to cause the terminal 20 to display a result processed by the server 10.

The present disclosure has been described with reference to the drawings and embodiments. Note that a person skilled in the art can easily make various transformations and modifications based on the present disclosure. Therefore, it should be noted that transformations and modifications are within in the scope of the present inventive concept. For example, the functions or the like included in functional units, steps, and the like are relocatable as long as not introducing logical contradiction, and multiple functional units, steps, and the like can be combined into one entity, or can be further divided. Also, the elements described in the respective embodiments may be appropriately combined.

What is claimed is:

1. A non-transitory computer-readable recording medium having computer readable instructions stored thereon, which when executed by a processor of a first information processing terminal, configures the first information processing terminal to,
display a screen of a chat room on the first information processing terminal such that the screen includes communications exchanged within the chat room between the first information processing terminal and a second information processing terminal;
display a list of objects based on an input received from a user of the first information processing terminal;
display the screen displayed on the first information processing terminal such that the screen includes a selected object selected by the user from the list of objects;
transmit the selected object to the second information processing terminal; and
display the screen on the first information processing terminal such that the screen includes an extended function.

2. The non-transitory computer-readable recording medium of claim 1, wherein the extended function is executed to search for a product or a service corresponding to the selected object to generate an execution result.

3. The non-transitory computer-readable recording medium of claim 2, wherein the computer readable instructions, when executed by the processor, further configures the processor to,
request execution of the extended function to generate the execution result,
modify the screen to include the execution result in response to execution of the extended function displayed in the chat room, wherein
in response to execution of the extended function, the execution result is transmitted to both the first information processing terminal and the second information processing terminal such that the execution result is displayable on both the first information processing terminal and the second information processing terminal.

4. The non-transitory computer-readable recording medium of claim 2, wherein the computer readable instructions, when executed by the processor, further configures the processor to,
request execution of the extended function to generate the execution result, and
modify the screen displayed to include the execution result in response to execution of the extended function displayed in the chat room, wherein
in response to execution of the extended function, the execution result is only transmitted to the first information processing terminal such that the execution result is not displayed on the second information processing terminal.

5. The non-transitory computer-readable recording medium of claim 3, wherein the computer readable instructions, when executed by the processor, further configures the processor to,
receive, from the user, one or more conditions associated with executing the extended function, wherein the processor is configured to,
request execution of the extended function based on the one or more conditions to generate the execution result, and
modify the screen displayed to include the execution result.

6. The non-transitory computer-readable recording medium of claim 2, wherein the computer readable instructions, when executed by the processor, further configures the processor to,
receive the execution result in response to a user of the second information processing terminal requesting execution of the extended function, and
modify the screen displayed on the first information processing terminal to include the execution result.

7. The non-transitory computer-readable recording medium of claim 2, wherein at least one result included in the execution result is associated with a supplemental function, and the computer readable instructions, when executed by the processor, further configures the processor to,
request execution of the supplemental function in response to selection of the at least one result associated therewith to generate supplemental information.

8. The non-transitory computer-readable recording medium of claim 7, wherein the computer readable instructions, when executed by the processor, further configures the processor to,
modify the screen displayed to include the supplemental information such that the supplemental information is embedded in the chat room in chronological order amongst the communications exchanged within the chat room.

9. The non-transitory computer-readable recording medium of claim 1, wherein the object is a stamp corresponding to a character string input by the user.

10. A method of processing information processing by a first information processing terminal, the first information processing terminal including at least one processor and a display, the method comprising:
displaying a screen of a chat room on the first information processing terminal such that the screen includes communications exchanged within the chat room between the first information processing terminal and a second information processing terminal;
displaying a list of objects based on an input received from a user of the first information processing terminal;
displaying the screen on the first information processing terminal such that the screen includes a selected object selected by the user from the list of objects;
transmitting the selected object to the second information processing terminal; and
displaying the screen on the first information processing terminal such that the screen includes an extended function.

11. A method of processing information by an information processing apparatus, the information processing apparatus including at least one processor, the method comprising:
receiving, a first information processing terminal, a selected object selected by a user of the first information processing terminal from amongst a list of objects displayed on a screen that displays a chat room on the first information processing terminal, the first information processing terminal configured to modify the screen to include an extended function;
receiving, from the first information processing terminal, an execution request requesting execution of the extended function;
executing the function in response to the execution request to generate an execution result; and
transmitting the execution result to the first information processing terminal.

12. A first information processing terminal, comprising:
a display; and
at least one processor configured to,
display a screen of a chat room on the first information processing terminal such that the screen includes communications exchanged within the chat room between the first information processing terminal and a second information processing terminal,
display a list of objects based on an input received from a first user associated with the first information processing terminal,
display the screen on the first information processing terminal such that the screen includes a selected object selected by the first user from the list of objects,
transmit the selected object to the second information processing terminal, and
display the screen on the first information processing terminal such that the screen includes an extended function.

13. The first information processing terminal of claim 12, wherein the at least one processor is configured to embed the extended function in the chat room in chronological order amongst the communications exchange within the chat room such that that the extended function is visible to and selectable by the first user associated with the first information processing terminal and a second user associated with the second information processing terminal.

14. The first information processing terminal of claim 13, wherein the at least one processor is configured to,
receive, from the first user, a request to transmit the input to the chat room such that the input is a message associated with the communications between the first user and other users within the chat room,
generate the list of objects by searching a database based on the input such that the list of objects contains objects related to the message,
display the list of objects within the screen such that the list of objects and the chat room are simultaneously displayed on the screen,
receive an input from the first user selecting the selected object from amongst the list of objects, and
request an external server to execute a process corresponding to the extended function in response to selection of the extended function by the first user.

15. The first information processing terminal of claim 14, wherein the at least one processor is configured to,
receive an execution result from the external server, the execution result including an identification number identifying the chat room,
modify the screen to include the execution result associated with the chat room based on the identification number such that the execution result is embedded in the chat room in chronological order amongst the communications exchanged within the chat room, and
instruct the second information processing terminal to display the execution result on a display associated therewith.

16. The first information processing terminal of claim 15, wherein in response to selection of the execution result, the at least one processor is further configured to,
initiate a browser window on the first information processing terminal to allow the first user to facilitate a transaction via the external server,
receive supplemental information from the external server in response to completion of the transaction,
modify the screen to include the supplemental information such that the supplemental information is embedded in the chat room in chronological order amongst the communications exchanged within the chat room.

17. The first information processing terminal of claim 16, wherein the at least one processor is configured to embed the supplemental information in the chat room in chronological order amongst the communications exchange within the chat room such that the supplemental information is simultaneously visible to the first user and the second user.

18. The first information processing terminal of claim 17, wherein the at least one processor is configured to,
receive a share request from the first user requesting the first information processing terminal share the supplemental information with the chat room, and
embed the supplemental information in the chat room in chronological order amongst the communications exchange within the chat room, in response to the share request.

19. The non-transitory computer-readable recording medium of claim 1, wherein the computer readable instructions, when executed by the processor, configures the processor to modify the screen displayed on the first information processing terminal to include the extended function such that the extended function is embedded in the chat room in chronological order amongst the communications exchanged within the chat room.

20. The method of claim 10, wherein the displaying the screen to include the extended function modifies the screen such that the extended function is embedded in the chat room in chronological order amongst the communications exchanged within the chat room.

21. The first information processing terminal of claim 12, wherein the at least one processor is configured to modify the screen to include the extended function such that the extended function is embedded in the chat room in chronological order amongst the communications exchanged within the chat room.
